(19) United States
(12) Patent Application Publication
(10) Pub. No.: US 2009/0225208 A1
(43) Pub. Date: Sep. 10, 2009

(54) Solid-State Image Sensing Device, Amplification Method, and Imaging Apparatus

(76) Inventors: Atsushi Yoshizawa, Kanagawa (JP); Sachio Iida, Chiba (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/369,912

(22) Filed: Feb. 12, 2009

(30) Foreign Application Priority Data
Mar. 10, 2008 (JP) P2008-060331

(51) Int. Cl. H04N 5/335

(52) U.S. Cl. 348/300; 348/308; 348/E05.091

(57) ABSTRACT

A solid-state image sensing device includes a pixel unit that includes pixels, each of pixels outputting the pixel signal to a signal line connected thereto; and an amplifying unit that includes amplifiers connected to the corresponding signal lines. The amplifier includes a first variable capacitance element, a second variable capacitance element, and an input unit that selectively inputs the pixel signal to the first variable capacitance element and the second variable capacitance element. The amplifier sets the capacitances of the first variable capacitance element and the second variable capacitance element to a first value when the pixel signal is input to the first variable capacitance element and the second variable capacitance element. And the amplifier changes the capacitances of the first variable capacitance element and the second variable capacitance element to a second value that is smaller than the first value, thereby amplifying the pixel signal.

### CROSS REFERENCES TO RELATED APPLICATIONS

The present invention contains subject matter related to Japanese Patent Application JP 2008-060331 filed in the Japan Patent Office on Mar. 10, 2008, the entire contents of which being incorporated herein by reference.

### BACKGROUND OF THE INVENTION

1. Field of the Invention

The present invention relates to a solid-state image sensing device, an amplification method, and an imaging apparatus.

2. Description of the Related Art

In recent years, imaging apparatuses having an image capturing function of capturing still pictures or moving pictures, such as digital still cameras, digital video cameras, such as Handycam, which is a trademark registered by the applicant, and mobile phones having the function of a digital camera, have come into widespread use. The imaging apparatus includes a CCD (charge coupled device) image sensor or a CMOS (complementary metal oxide semiconductor) image sensor as a solid-state image sensing device and uses the image sensor to capture an image. In the related art, the CCD image sensor has been generally used as the solid-state image sensing device in the imaging apparatus since the S/N ratio (signal-to-noise ratio) of the CCD image sensor is more than that of the CMOS image sensor. However, in recent years, in the imaging apparatus, the CMOS image sensor has been widely used as the solid-state image sensing device and drawn attention as an important device for the following reasons: with an improvement in the structure of a circuit or a device, the S/N ratio of the CMOS image sensor is improved; the data read speed of the CMOS image sensor is higher than that of the CCD image sensor; and the CMOS image sensor is more suitable for SoC (system on chip) than the CCD image sensor.

The CMOS image sensor according to the related art that has come into widespread use is implemented by, for example, a so-called APS (active pixel sensor) technology. The APS-type CMOS image sensor includes a photodiode (photoelectric conversion element) and an active element (for example, a transistor) in each pixel, and the active element prevents the attenuation of a signal that is generated by the photodiode in response to inputted light. In addition, the CMOS image sensor according to the related art includes, for example, pixels arranged in a matrix, signal lines that are arranged in a row direction and are connected to each row of pixels, amplifiers (so-called column amplifiers) that are connected to the signal lines and amplify signals output from the pixels, and a multiplexer that multiplexes the amplified signals output from the amplifiers. The CMOS image sensor having the above-mentioned structure can obtain image signals corresponding to the captured image of a subject.

The CMOS image sensor according to the related art uses an amplifier including, for example, a switched capacitor circuit or an operational amplifier to amplify the signal output from each pixel. However, the switched capacitor circuit or the operational amplifier included in the amplifier of the CMOS image sensor according to the related art is a circuit or an element having a large size. Therefore, with an increase in the resolution of a solid-state image sensing device, the number of necessary amplifiers is increased, and the circuit area of the amplifiers is increased. In addition, since the amplifier of the CMOS image sensor according to the related art uses an operational amplifier to amplify signals, the sensitivity of the solid-state image sensing device is lowered due to noise generated by the operational amplifier. Further, the amplifier of the CMOS image sensor according to the related art amplifies signals using the operational amplifier that consumes a large amount of power to amplify the signals. Therefore, as the number of amplifiers is increased with an increase in resolution, it is difficult to reduce the overall power consumption of the solid-state image sensing device.

In order to solve the above-mentioned issues, a technique has been developed which uses variable capacitance elements to amplify signals. For example, US2005/275,026 discloses a technique that uses a discrete-time parametric amplifier (MOSFET parametric amplifier) including a MOSFET (metal oxide semiconductor field effect transistor) to reduce the power consumption and the size of an RF (radio frequency) circuit. In addition, JP 04-18737 A discloses a technique that uses a variable capacitance element as an amplifier of a CCD image sensor.

### SUMMARY OF THE INVENTION

However, the MOSFET parametric amplifier according to the related art amplifies an overlap signal of a bias voltage and a voltage signal input to the MOSFET parametric amplifier. Therefore, the level of an output voltage signal of the MOSFET parametric amplifier is excessively high, and it is difficult to treat the output signal. For example, a component that is arranged in the next stage of the amplifier and receives the output signal needs to have high voltage resistance. When the level of the output signal of the MOSFET parametric amplifier is excessively high, it is difficult to reduce the power consumption or the size of a circuit. When the level of the output voltage signal of the MOSFET parametric amplifier is higher than that of a power supply voltage (control signal), the capacitance of a MOSFET is reduced, and distortion occurs in the waveform of the output voltage signal.

Furthermore, since the amplifier used for the CCD image sensor according to the related art includes a MOS capacitor as the variable capacitance element, the same issues as those in the MOSFET parametric amplifier arise.

Therefore, even though the technique in the related art for using a variable capacitance element to amplify signals is applied to the amplifier (a so-called column amplifier) of the CMOS image sensor, distortion occurs in the waveform of the output voltage signal. As a result, it is difficult to prevent a reduction in the sensitivity of a solid-state image sensing device. In addition, it is difficult to sufficiently reduce power consumption.

It is desirable to provide a solid-state image sensing device, an amplification method, and an imaging apparatus capable of preventing a reduction in the sensitivity of the solid-state image sensing device and reducing power consumption.

According to an embodiment of the present invention, there is provided a solid-state image sensing device including a pixel unit that includes pixels arranged in a matrix, each of pixels having a photoelectric conversion element that generates a pixel signal corresponding to inputted light, and selectively outputting the pixel signal to a signal line connected thereto, and an amplifying unit that includes amplifiers connected to the corresponding signal lines and amplifies the pixel signals transmitted through the signal lines. The amplifier includes a first variable capacitance element that has a variable capacitance, a second variable capacitance element that has a variable capacitance and is electrically connected to the first variable capacitance element, and an input unit that selectively inputs the pixel signal to the first variable capacitance element and the second variable capacitance element. The amplifier sets the capacitances of the first variable capacitance element and the second variable capacitance element to a first value when the pixel signal is input to the first variable capacitance element and the second variable capacitance element. And the amplifier changes the capacitances of the first variable capacitance element and the second variable capacitance element to a second value that is smaller than the first value, thereby amplifying the pixel signal.

According to the above-mentioned structure, it is possible to prevent a reduction in the sensitivity of a solid-state image sensing device and reduce power consumption.

The amplifier may further include a third variable capacitance element that is electrically connected to the first variable capacitance element and the second variable capacitance element and has a variable capacitance, and a fourth variable capacitance element that is electrically connected to the first variable capacitance element, the second variable capacitance element, and the third variable capacitance element and has a variable capacitance. The capacitances of the third variable capacitance element and the fourth variable capacitance element may be changed to the first value or the second value in synchronization with the first variable capacitance element and the second variable capacitance element.

According to the above-mentioned structure, it is possible to more reliably prevent a reduction in the sensitivity of a solid-state image sensing device and reduce power consumption.

The first variable capacitance element and the second variable capacitance element may be MOS varactors having opposite conduction types. Gate terminals of the first variable capacitance element and the second variable capacitance element may be connected to the input unit. A control signal having a first level or a control signal having a second level that is higher than the first level may be input to source and drain terminals of the first variable capacitance element and source and drain terminals of the second variable capacitance element. The voltage level of the control signal input to the source and drain terminals of the first variable capacitance element may be different from that of the control signal input to the source and drain terminals of the second variable capacitance element.

According to the above-mentioned structure, it is possible to amplify pixel signals without generating noise.

The capacitances of the first variable capacitance element and the second variable capacitance element may be changed to the first value when the pixel signal is input to the first variable capacitance element and the second variable capacitance element. And the capacitances of the first variable capacitance element and the second variable capacitance element may be changed to the second value when the control signal having the first level is input to the source and drain terminals of the first variable capacitance element.

According to the above-mentioned structure, it is possible to amplify pixel signals by the capacitance change ratio of the capacitances.

The first variable capacitance element and the second variable capacitance element may be n-channel MOS varactors. The source and drain terminals of the first variable capacitance element and the gate terminal of the second variable capacitance element may be connected to the input unit. A control signal having a first level or a control signal having a second level that is higher than the first level may be input to the gate terminal of the first variable capacitance element and the source and drain terminals of the second variable capacitance element. The voltage level of the control signal input to the gate terminal of the first variable capacitance element may be different from that of the control signal input to the source and drain terminals of the second variable capacitance element.

According to the above-mentioned structure, it is possible to amplify pixel signals without generating noise.

The first variable capacitance element and the second variable capacitance element may be p-channel MOS varactors. A gate terminal of the first variable capacitance element and the source and drain terminals of the second variable capacitance element may be connected to the input unit. A control signal having a first level or a control signal having a second level that is higher than the first level may be input to the source and drain terminals of the first variable capacitance element and the gate terminal of the second variable capacitance element. The voltage level of the control signal input to the source and drain terminals of the first variable capacitance element may be different from that of the control signal input to the gate terminal of the second variable capacitance element.

According to the above-mentioned structure, it is possible to amplify pixel signals without generating noise.

According to the embodiments of the present invention described above, there is provided an amplification method that is applicable to a solid-state image sensing device including a pixel unit that includes pixels arranged in a matrix, each of pixels having a photoelectric conversion element that generates a pixel signal corresponding to inputted light, and selectively outputting the pixel signal to a signal line connected thereto, and an amplifying unit that includes amplifiers, each having a first variable capacitance element having a variable capacitance and a second variable capacitance element having a variable capacitance, connected to the signal lines and amplifies the pixel signals transmitted through the signal lines. The amplification method includes the steps of inputting the pixel signal to the first variable capacitance element and the second variable capacitance element to store a first charge corresponding to a first capacitance, holding the first charge, and reducing the capacitances of the first variable capacitance element and the second variable capacitance element from the first capacitance to a second capacitance that is smaller than the first capacitance, thereby amplifying the pixel signal.

The above-mentioned method can be used to prevent a reduction in the sensitivity of a solid-state image sensing device and reduce power consumption.

According to the embodiments of the present invention described above, there is provided an imaging apparatus including a solid-state image sensing device including a pixel unit that includes pixels arranged in a matrix, each of pixels having a photoelectric conversion element that generates a pixel signal corresponding to inputted light, and selectively outputting the pixel signal to a signal line connected thereto, and an amplifying unit that includes amplifiers connected to the signal lines and amplifies the pixel signals transmitted through the signal lines, and a signal processing unit that processes the pixel signals output from the solid-state image sensing device. Each of the amplifiers included in the amplifying unit of the solid-state image sensing device includes a first variable capacitance element that has a variable capacitance, a second variable capacitance element that has a variable capacitance and is electrically connected to the first variable capacitance element, and an input unit that selectively inputs the pixel signal to the first variable capacitance element and the second variable capacitance element. When the pixel signal is input to the first variable capacitance element and the second variable capacitance element, the amplifier sets the capacitances of the first variable capacitance element and the second variable capacitance element to a first value, and the amplifier changes the capacitances of the first variable capacitance element and the second variable capacitance element to a second value that is smaller than the first value, thereby amplifying the pixel signal.

According to the above-mentioned structure, it is possible to prevent a reduction in the sensitivity of a solid-state image sensing device and reduce power consumption.

According to the embodiments of the present invention described above, it is possible to prevent a reduction in the sensitivity of a solid-state image sensing device and reduce power consumption.

### BRIEF DESCRIPTION OF THE DRAWINGS

FIG. 1 is a diagram illustrating the structure of an imaging device according to the related art.

FIG. 2 is a diagram illustrating a first structural example of an amplifier of a solid-state image sensing device according to the related art.

FIGS. 3A to 3C are diagrams illustrating the principle of amplification of a voltage signal by a MOSFET parametric amplifier.

FIGS. 4A and 4B are diagrams illustrating the structure of an n-MOSFET of the MOSFET parametric amplifier according to the related art.

FIGS. 5A and 5B are diagrams illustrating a second structural example of an amplifier 16a of the solid-state image sensing device according to the related art.

FIGS. 6A to 6C are diagrams illustrating the waveforms of signals related to the MOSFET parametric amplifier according to the related art shown in FIG. 5.

FIGS. 7A and 7B are diagrams illustrating the cause of the distortion of an output voltage signal of the MOSFET parametric amplifier according to the related art.

FIG. 8 is a diagram illustrating an example of the structure of a solid-state image sensing device according to an embodiment of the present invention.

FIGS. 9A and 9B are first diagrams illustrating the first principle of amplification by an amplifier according to the embodiment of the present invention.

FIGS. 10A to 10C are second diagrams illustrating the first principle of amplification by the amplifier according to the embodiment of the present invention.

FIGS. 11A to 11C are diagrams illustrating the second principle of amplification by the amplifier according to the embodiment of the present invention.

FIG. 12 is a diagram illustrating an example of the structure of a pixel of the solid-state image sensing device according to the embodiment of the present invention.

FIG. 13 is a first diagram illustrating an amplifier according to a first structural example provided in the solid-state image sensing device according to the embodiment of the present invention.

FIG. 14 is a second diagram illustrating the amplifier according to the first structural example provided in the solid-state image sensing device according to the embodiment of the present invention.

FIGS. 15A to 15C are third diagrams illustrating the amplifier according to the first structural example provided in the solid-state image sensing device according to the embodiment of the present invention.

FIG. 16 is a first diagram illustrating an amplifier according to a second structural example provided in the solid-state image sensing device according to the embodiment of the present invention.

FIG. 17 is a second diagram illustrating the amplifier according to the second structural example provided in the solid-state image sensing device according to the embodiment of the present invention.

FIGS. 18A to 18C are third diagrams illustrating the amplifier according to the second structural example provided in the solid-state image sensing device according to the embodiment of the present invention.

FIG. 19 is a first diagram illustrating an amplifier according to a third structural example provided in the solid-state image sensing device according to the embodiment of the present invention.

FIG. 20 is a second diagram illustrating the amplifier according to the third structural example provided in the solid-state image sensing device according to the embodiment of the present invention.

FIG. 21 is a first diagram illustrating an amplifier according to a fourth structural example provided in the solid-state image sensing device according to the embodiment of the present invention.

FIG. 22 is a second diagram illustrating the amplifier according to the fourth structural example provided in the solid-state image sensing device according to the embodiment of the present invention.

FIGS. 23A to 23C are third diagrams illustrating the amplifier according to the fourth structural example provided in the solid-state image sensing device according to the embodiment of the present invention.

FIGS. 24A and 24B are diagrams schematically illustrating a p-MOS varactor P1 of the amplifier according to the fourth structural example provided in the solid-state image sensing device according to the embodiment of the present invention.

FIGS. 25A and 25B are diagrams schematically illustrating an n-MOS varactor N2 of the amplifier according to the fourth structural example provided in the solid-state image sensing device according to the embodiment of the present invention.

FIGS. 26A and 26B are diagrams schematically illustrating an n-MOS varactor N1 of the amplifier according to the fourth structural example provided in the solid-state image sensing device according to the embodiment of the present invention.

FIGS. 27A and 27B are diagrams schematically illustrating a p-MOS varactor P2 of the amplifier according to the fourth structural example provided in the solid-state image sensing device according to the embodiment of the present invention.

FIG. 28 is a diagram illustrating an amplifier according to a fifth structural example provided in the solid-state image sensing device according to the embodiment of the present invention.

FIG. 29 is a diagram illustrating an example of the operation of the amplifier of the solid-state image sensing device according to the embodiment of the present invention.

FIG. 30 is a flowchart illustrating an example of an amplification method performed in the amplifier of the solid-state image sensing device according to the embodiment of the present invention.

FIG. 31 is a diagram illustrating an example of the hardware structure of an imaging apparatus according to the embodiment of the present invention.

### DETAILED DESCRIPTION OF THE PREFERRED EMBODIMENTS

Hereafter, preferred embodiments of the present invention will be described in detail with reference to the appended drawings. Note that in this specification and the appended drawings, structural elements that have substantially the same functions and structures are denoted with the same reference numerals and a repeated explanation of these structural elements is omitted.

### (Issues of Solid-State Image Sensing Device According to the Related Art)

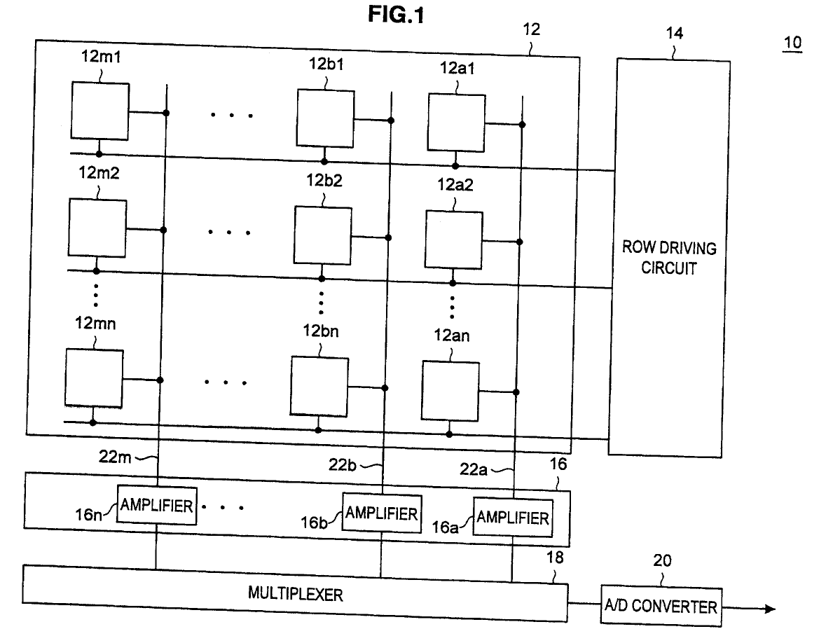

Before a solid-state image sensing device according to an embodiment of the present invention is described, the issues of a solid-state image sensing device according to the related art will be described. FIG. 1 is a diagram illustrating the structure of a solid-state image sensing device 10 according to the related art. FIG. 1 shows a CMOS image sensor as the solid-state image sensing device.

Referring to FIG. 1, the solid-state image sensing device 10 includes a pixel unit 12, a row driving circuit 14, an amplifying unit 16, a multiplexer 18, and an A/D converter 20.

The pixel unit 12 includes pixels 12a1 to 12mn (m and n are positive integers) arranged in a matrix. The pixels included in the pixel unit 12 each include a photodiode (photoelectric conversion element) that generates a pixel signal corresponding to inputted light, arid output the pixel signals to signal lines 22a to 22m connected thereto in response to selection signals transmitted from the row driving circuit 14.

The row driving circuit 14 selectively supplies the selection signals to the pixels in the pixel unit 12 to control the pixels that output the pixel signals. For example, when the row driving circuit 14 supplies the selection signal to each row of pixels in the pixel unit 12, the pixel signals corresponding to the pixels supplied with the selection signal among the pixels connected to the signal lines are transmitted to the signal lines.

The amplifying unit 16 includes an amplifier 16a connected to the signal line 22a , an amplifier 16b connected to the signal line 22b , . . . , an amplifier 16n connected to the signal line 22m.

The multiplexer 18 multiplexes the pixel signals amplified by the amplifiers and outputs the multiplexed pixel signal (hereinafter, referred to as an ‘image signal’) to the A/D converter 20 (analog-to-digital converter).

The A/D converter 20 converts the image signal output from the multiplexer 18 into a digital signal. The converted digital image signal is transmitted to, for example, a signal processing circuit (not shown) of an imaging apparatus (not shown), and the signal processing circuit (not shown) performs various processes, such as a JPEG (joint photographic experts group) coding process.

The solid-state image sensing device 10 can obtain image signals corresponding to the captured image of a subject using, for example, the structure shown in FIG. 1.

### [Structure of Amplifier of Solid-State Image Sensing Device 10 According to the Related Art and Issues of Solid-State Image Sensing Device 10]

Hereinafter, the structure of the amplifier of the solid-state image sensing device 10 and the issues of the solid-state image sensing device 10 including the amplifier will be described. In addition, in the following description, the amplifier 16a among the amplifiers of the solid-state image sensing device 10 is given as an example.

### [i] First Structural Example of Amplifier 16a and Issues Occurring in Solid-State Image Sensing Device 10

[i-1] First Structural Example of Amplifier 16a: Amplifier Using Operational Amplifier

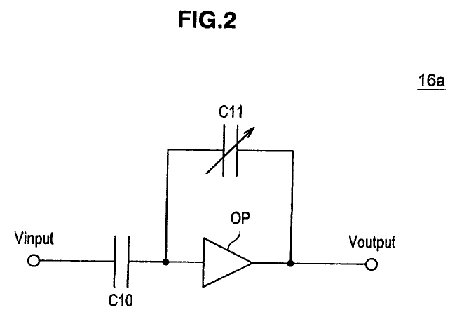

FIG. 2 is a diagram illustrating a first structural example of the amplifier 16a included in the solid-state image sensing device 10, according to the related art. Referring to FIG. 2, the amplifier 16a includes an operational amplifier OP, a switched capacitor circuit C10 (a switch is not shown), and a switched capacitor circuit C11 (a switch is not shown).

The amplifier 16a having the above-mentioned structure shown in FIG. 2 amplifies an input pixel signal Vinput with a gain corresponding to the ratio of the capacitance of the switched capacitor circuit C11, serving as a feedback circuit of the operational amplifier OP, to the capacitance of the switched capacitor circuit C10. That is, for example, the amplifier 16a shown in FIG. 2 can switch the capacitance of the switched capacitor circuit C11 using, for example, a switch to change the gain.

[i-2] Issues Occurring in Solid-State Image Sensing Device 10 Due to Amplifier Having First Structural Example

However, since the amplifier 16a shown in FIG. 2 includes circuits or elements having a large area, such as the switch-capacitor circuits C10 and C11 and the operational amplifier OP, it is difficult to reduce the overall size of the amplifier. With an increase in the resolution of a solid-state image sensing device, as the number of pixels in the pixel unit 12 is increased, the number of signal lines is increased. In addition, when the number of signal lines is increased, the number of amplifiers in the amplifying unit 16 is increased. Therefore, as the resolution of the solid-state image sensing device 10 is increased, the circuit size of the amplifying unit 16 is increased, which results in an increase in the size of the solid-state image sensing device 10.

Further, since the amplifier 16a shown in FIG. 2 uses the operational amplifier OP to amplify the pixel signal transmitted through the signal line, noise generated by the operational amplifier OP is mixed with the amplified pixel signal Voutput. Therefore, the sensitivity of the solid-state image sensing device 10 including the amplifier 16a shown in FIG. 2 is lowered due to the noise generated by the operational amplifier OP.

Furthermore, since the amplifier 16a shown in FIG. 2 uses the operational amplifier OP to amplify the pixel signal transmitted through the signal line, predetermined power needs to be consumed in order to amplify the pixel signal. In this case, as described above, as the resolution of the solid-state image sensing device 10 is increased, the number of amplifiers in the amplifying unit 16 is increased, which results in an increase in power consumption. Therefore, it is difficult to reduce the overall power consumption of the solid-state image sensing device 10 including the amplifier 16a shown in FIG. 2.

As described above, for example, the solid-state image sensing device 10 including the amplifier 16a shown in FIG. 2 has issues in that the size of the solid-state image sensing device 10 is increased, the sensitivity thereof is lowered, and it is difficult to reduce the overall power consumption of the solid-state image sensing device due to the structure of the amplifier 16a.

[ii] Second Structural Example of Amplifier 16a and Issues Occurring in Solid-State Image Densing device 10

An amplifier that amplifies signals without using an operational amplifier is given as a second structural example of the amplifier 16a included in the solid-state image sensing device 10. Next, a structure in which a discrete-time parametric amplifier (MOSFET parametric amplifier) is used as the amplifier according to the second structural example that amplifies signals without using an operational amplifier will be described.

[ii-1] Principle of Amplification of Discrete-Time Parametric Amplifier

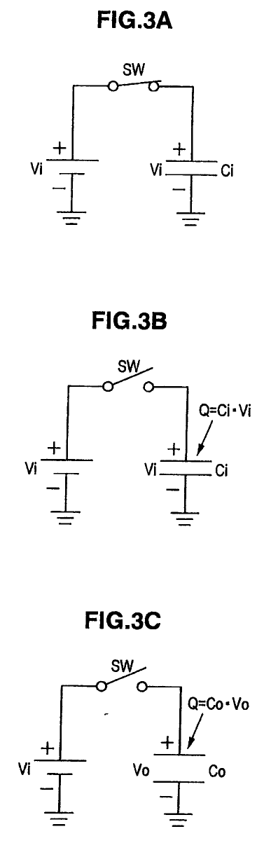

FIGS. 3A to 3C are Diagrams Illustrating the Principle of Amplification of a Voltage Signal by the Discrete-Time Parametric amplifier. FIG. 3A shows a track state in which the discrete-time parametric amplifier stores charge, and FIG. 3B shows a hold state in which the discrete-time parametric amplifier holds the stored charge. FIG. 3C shows a boost state in which the discrete-time parametric amplifier amplifies a voltage.

Referring to FIGS. 3A to 3C, the discrete-time parametric amplifier includes, for example, a power supply (for example, which corresponds to each pixel in FIG. 1) that outputs an input voltage Vi, a variable capacitance element that has a variable capacitance, and a switch SW that controls the input of the input voltage Vi to the variable capacitance element.

The outline of the operation of the parametric amplifier will be described below. First, in the track state (FIG. 3A), the switch SW is turned on, and the input voltage Vi is applied to the variable capacitance element having a capacitance of Ci through the switch SW. Then, charge Q (=Ci·Vi), which is the product of the input voltage Vi and the capacitance Ci of the variable capacitance element, is stored between both ends of the variable capacitance element.

In the track state, when the switch SW is turned off and the parametric amplifier is changed to the hold state (FIG. 3B), the charge Q stored in the track state is held in the variable capacitance element. As a result, a potential difference between both electrodes of the variable capacitance element is held at the input voltage Vi immediately before the switch SW is turned off.

In the hold state, as shown in FIG. 3C, when the capacitance of the variable capacitance element is changed from Ci to Co, the potential difference between both electrodes of the variable capacitance element is changed as represented by Formula 1 given below.

Vo=Q/Co=Ci/Co·Vi=kVi(k=Ci/Co,0<Co,0, 0<Ci) [Formula 1]

As shown in Formula 1, the potential difference between two electrodes after the capacitance is changed is proportional to (Ci/Co). Therefore, when the capacitance of the variable capacitance element satisfies Co<Ci, it is possible to boost (amplify) the potential difference between the two electrodes of the variable capacitance element by ‘k’ times (when Ci<Co, the potential difference between the electrodes is reduced). In the Formula 1, ‘k’ indicates a capacitance change ratio.

[ii-2] Structure and Issues of MOSFET Parametric Amplifier According to the Related Art

Next, the issues of the MOSFET parametric amplifier according to the related art using the principle of the discrete-time parametric amplifier will be described.

### [First Issue]

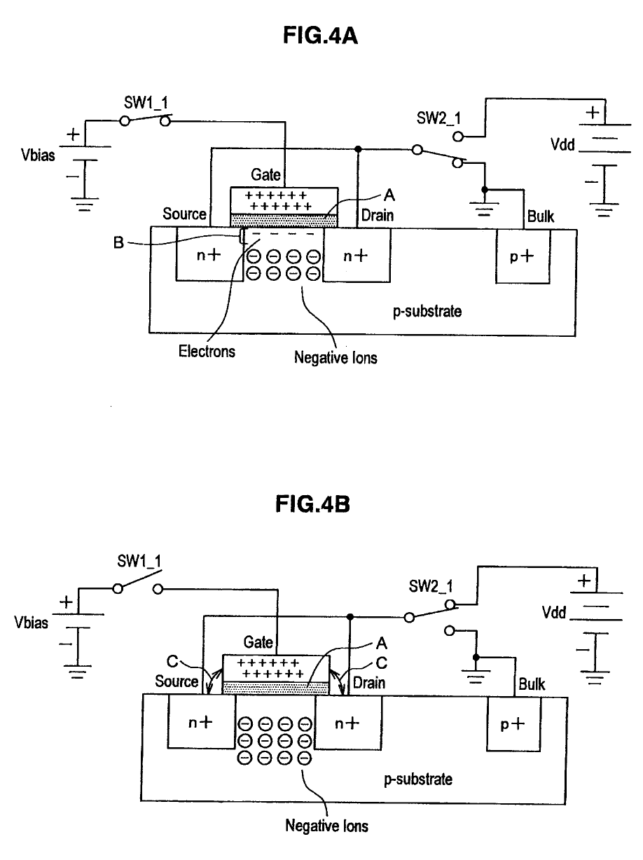

FIGS. 4A and 4B are diagrams illustrating the structure of an n (negative)-MOSFET of the MOSFET parametric amplifier according to the related art. FIG. 4A shows the track state of the MOSFET parametric amplifier according to the related art, and FIG. 4B shows the boost state of the MOSFET parametric amplifier according to the related art.

As shown in FIGS. 4A and 4B, in the MOSFET parametric amplifier according to the related art, a bias voltage source is connected to a gate terminal of the n-MOSFET through a switch SW1_1, and a bias voltage Vbias is applied to the gate terminal depending on the connection state (ON/OFF state) of the switch SW1_1. In addition, the source and terminals of the n-MOSFET are connected to a power supply that outputs a power supply voltage Vdd (hereinafter, referred to as a ‘power supply voltage source’) or the ground through a switch SW2_1. That is, the voltage applied to the source terminal and the drain terminal of the MOSFET parametric amplifier varies depending on the connection state of the switch SW2_1. In addition, a bulk terminal is connected to the ground.

In the track state of the MOSFET parametric amplifier, the switch SW1_1 is turned on, and the switch SW2_1 is connected to the ground (FIG. 4A). As a result, the bias voltage Vbias is applied to the gate terminal, and the source terminal and the drain terminal is held at a ground voltage. When the bias voltage Vbias is set to be higher than a threshold voltage Vt of the n-MOSFET, the n-MOSFET is strongly inverted, an inversion layer B is formed at the interface between an oxide film A and a P-substrate, and electrons are stored. As a result, the capacitance of the n-MOSFET increases.

Then, as shown in FIG. 4B, when the switch SW1_1 is turned off and the switch SW2_1 is connected to the power supply voltage source, the power supply voltage Vdd is applied to the source terminal and the drain terminal, and the bias voltage Vbias is not applied to the gate terminal. In this state, the inversion layer B formed at the interface between the oxide film A and the P-substrate shown in FIG. 4A is removed by the power supply voltage Vdd applied to the source terminal and the drain terminal, and negative ions-increase, which results in a reduction in the capacitance of the n-MOSFET. In this case, since charge is held in the gate terminal, the connection states of the switches are changed as shown in FIG. 4B, and the capacitance of the n-MOSFET is changed. Then, the voltage of the gate terminal is changed to a value obtained by boosting (amplifying) the bias voltage Vbias by a capacitance change ratio (see Formula 1). The n-MOSFET is shown in FIGS. 4A and 4B. However, a p (positive)-MOSFET may be used. In this case, a reverse conduction type is used and the bulk terminal is connected to the power supply voltage source that outputs the power supply voltage Vdd. However, the principle of amplification of the voltage of the gate terminal is the same as that in the n-MOSFET. Next, the MOSFET parametric amplifier according to the related art will be described using the n-MOSFET.

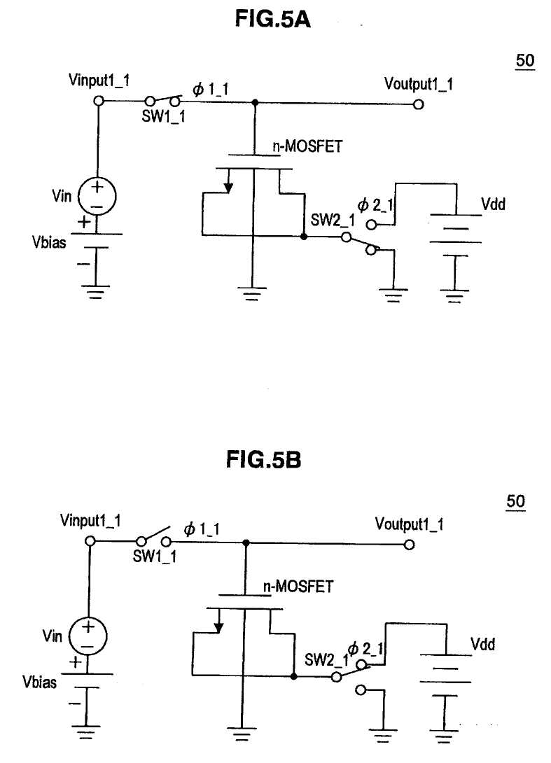

FIGS. 5A and 5B are diagrams illustrating the second structural example of the amplifier 16a included in the solid-state image sensing device according to the related art. FIGS. 5A and 5B show the circuit structure of the MOSFET parametric amplifier according to the related art shown in FIGS. 4A and 4B. FIG. 5A shows the track state of the MOSFET parametric amplifier according to the related art, and FIG. 5B shows the boost state of the MOSFET parametric amplifier according to the related art.

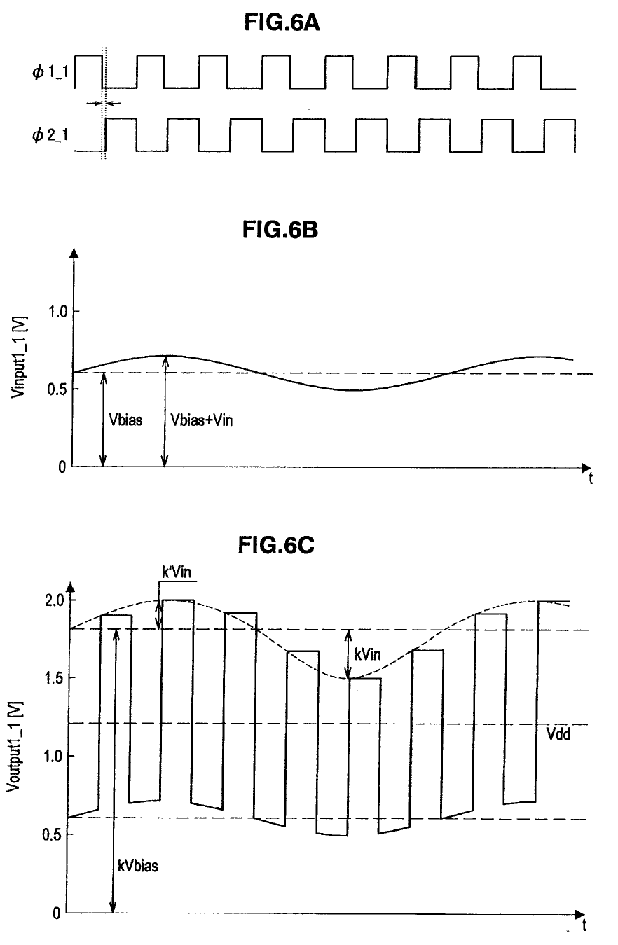

FIGS. 6A to 6C are diagrams illustrating the waveforms of signals related to a MOSFET parametric amplifier 50 according to the related art shown in FIGS. 5A and 5B. FIG. 6A shows control clock signals that control switches of the MOSFET parametric amplifier 50 according to the related art shown in FIGS. 5A and 5B, and FIG. 6B shows an input voltage signal Vinput1_1 that is input to the MOSFET parametric amplifier 50. In addition, FIG. 6C shows an output voltage signal Voutput1_1 that is output from the MOSFET parametric amplifier 50.

As shown in FIG. 6B, the input voltage signal Vinput1_1 input to the MOSFET parametric amplifier 50 is an overlap signal of the bias voltage Vbias and the voltage signal Vin.

For example, a case in which the following relationships (1) and (2) are established in the MOSFET parametric amplifier 50 will be described as an example.

(1) The switch SW1_1 is operated in synchronization with a clock signal φ1_1 shown in FIG. 6A, is turned on when the clock signal φ1_1 is at a high level, and is turned off when the clock signal φ1_1 is at a low level.

(2) The switch SW2_1 is operated in synchronization with a clock signal φ2_1 shown in FIG. 6A, is connected to the power supply voltage source when the clock signal φ2_1 is at a high level, and is connected to the ground when the clock signal φ2_l is at a low level.

In this case, when the clock signal φ1_1 is at the high level, the switch SW1_1 is turned on. At that time, since the clock signal φ2_1, which is an inverted signal of the clock signal φ1_1, is at the low level, the switch SW2_1 is connected to the ground. As a result, the MOSFET parametric amplifier 50 is in the track state (FIG. 5A). That is, in the MOSFET parametric amplifier 50, an inversion layer is formed on one surface of the gate oxide film facing the p-substrate, and the voltage of the gate terminal varies so as to follow the input voltage signal Vinput1_1. As a result, charge is stored in the n-MOSFET.

Then, when the clock signal φ1_1 is changed to a low level, the switch SW1_1 is turned off. In this case, the clock signal φ2_1 follows the clock signal φ1_1 to be changed to a high level, and the switch SW2_1 is connected to the power supply voltage source (actually, there is a mismatch between the inversion timings of two signals, which will be described below). As a result, the MOSFET parametric amplifier 50 is changed to the boost state, and the capacitance of the n-MOSFET is reduced. In this case, since charge is held in the gate terminal of the n-MOSFET, the capacitance is changed as represented by Formula 1, and the input voltage signal Vinput1_1 is amplified by the capacitance change ratio. Although not shown in FIGS. 5A and 5B, during a period from the falling edge of the clock signal φ1_1 to the rising edge of the clock signal φ2_1 shown in FIG. 6A (that is, a time interval between the inversion timings of two signals), the MOSFET parametric amplifier is changed from the track state shown in FIG. 5A to the boost state shown in FIG. 5B through the hold state.

In this embodiment, the voltage (boost voltage) of the gate terminal of the n-MOSFET when the MOSFET parametric amplifier 50 is changed to the boost state, that is, the output voltage Voutput1_1 of the MOSFET parametric amplifier 50 is considered. In this case, as shown in FIG. 6C, the output voltage Voutput1_1 is obtained by amplifying the input voltage Vinput1_1 (=the bias voltage Vbias+the voltage signal Vin) by a capacitance change ratio (k times). That is, the bias voltage Vbias as well as the voltage signal Vin to be boosted is multiplied by the capacitance change ratio.

Therefore, in a circuit including the MOSFET parametric amplifier 50, the level of the output voltage Voutput1_1 is excessively high, which makes it difficult to reduce the power consumption and the size of the circuit. In FIG. 6C, distortion occurs in the output voltage Voutput1_1. For example, a portion of the amplified voltage signal Vin is amplified by k′ times (0<k′<k), which will be described below.

### [Second Issue]

In the first issue of the MOSFET parametric amplifier 50 according to the related art, the level of the output voltage Voutput1_1 is excessively high. However, as can be seen from FIG. 6C, distortion occurs in the output voltage Voutput1_1. Therefore, the second issue of the MOSFET parametric amplifier 50, that is, the issue of distortion occurring in the output voltage Voutput1_1 will be described below.

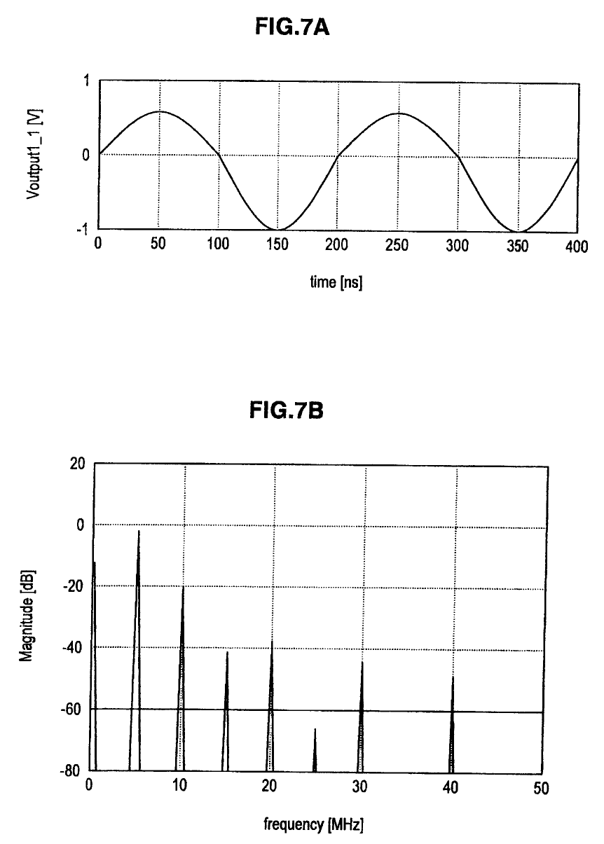

FIGS. 7A and 7B are diagrams illustrating the cause of the distortion of an output voltage signal Voutput in the MOSFET parametric amplifier 50 according to the related art. FIG. 7A shows the waveform of the output voltage signal Voutput1_1 shown in FIG. 6C with a frequency of 5 MHz that is extracted as a continuous time waveform. FIG. 7B shows the frequency spectrum of FIG. 7A.

Referring to FIG. 7B, there are a DC (direct current) component of −60 [dB] and a harmonic component having a frequency that is higher than 5 MHz in addition to a basic frequency of 5 MHz. The DC component and the harmonic component cause the distortion of the output voltage Voutput1_1. When the output voltage Voutput1_1 is higher than the power supply voltage Vdd, the capacitance of the n-MOSFET is reduced, which causes the distortion. That is, in FIG. 6C, as the capacitance change ratio is increased, the distortion of the output voltage Voutput1_1 is increased.

In this case, distortion occurring in the output voltage Voutput1_1 corresponds to noise generated by the amplification of the input voltage signal Vinput1_1. Therefore, when the MOSFET parametric amplifier 50 is used as the amplifier of the amplifying unit 12, noise generated by amplification is mixed with the pixel signal Voutput, similar to when the amplifier 16a according to the first structural example shown in FIG. 2 is used.

As described above, in the MOSFET parametric amplifier 50 according to the related art, both the bias voltage and the voltage signal input to the MOSFET parametric amplifier are amplified while overlapping each other. As a result, at least the above-mentioned two issues (difficulty in reducing the power consumption and the size of a circuit, and the generation of noise) arise.

[ii-3] Issues Occurring in Solid-State Image Sensing Device 10 Due to Amplifier According to Second Structural Example

As described above, in the amplifier according to the second structural example, that is, the MOSFET parametric amplifier 50, it is difficult to reduce the power consumption or the size of a circuit due to amplification. In this case, as described above, as the resolution of the solid-state image sensing device 10 is increased, the number of amplifiers in the amplifying unit 16 is increased, which makes it difficult to reduce the power consumption or the size of the solid-state image sensing device 10.

Further, in the amplifier according to the second structural example, as described above, noise is generated. Therefore, the sensitivity of the amplifier 16a composed of the MOSFET parametric amplifier 50 shown in FIGS. 5A and 5B is lowered due to noise generated by the MOSFET parametric amplifier 50.

Therefore, even though the solid-state image sensing device 10 includes the amplifier according to the related art that amplifies signals without using an operational amplifier, it is difficult to prevent a reduction in the sensitivity of a solid-state image sensing device and reduce power consumption.

### (Solid-State Image Sensing Device According to Embodiment of the Invention)

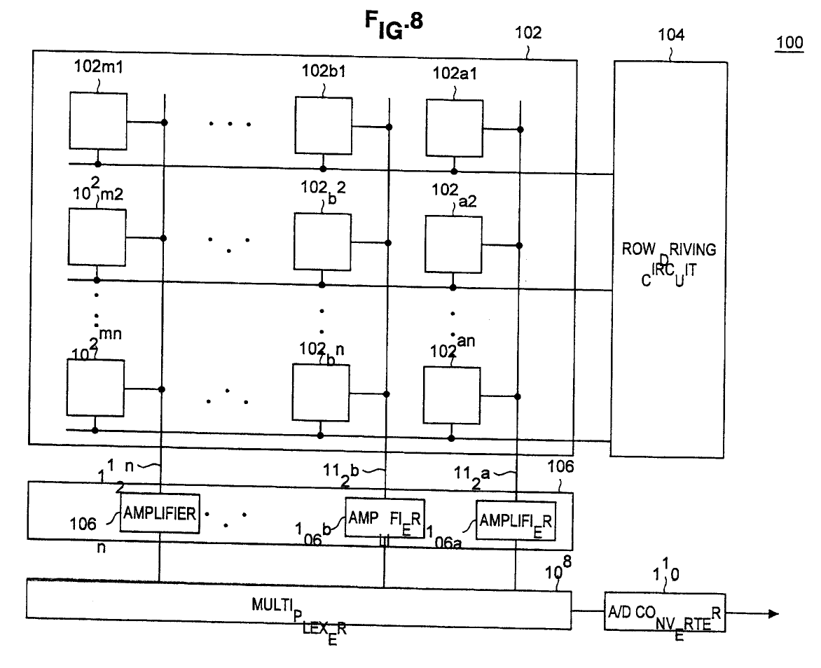

Next, a solid-state image sensing device according to an embodiment of the present invention will be described. FIG. 8 is a diagram illustrating an example of the structure of a solid-state image sensing device 100 according to an embodiment of the present invention. FIG. 8 shows a CMOS image sensor, similar to the solid-state image sensing device 10 according to the related art shown in FIG. 1. In the following description, a CMOS image sensor is given as an example of the solid-state image sensing device according to the embodiment of the present invention.

Referring to FIG. 8, the solid-state image sensing device 100 includes a pixel unit 102, a row driving circuit 104, an amplifying unit 106, a multiplexer 108, and an A/D converter 110. As can be seen from comparison between FIG. 1 and FIG. 8, the solid-state image sensing device 100 according to the embodiment of the present invention has the same basic structure as the solid-state image sensing device 10 according to the related art.

As described above, in the solid-state image sensing device 10 according to the related art, issues occur due to the structures of the amplifiers 16a to 16n of the amplifying unit 16. Specifically, when the solid-state image sensing device 10 according to the related art includes the amplifier (the amplifier shown in FIG. 2) using an operational amplifier, at least three issues, that is, difficulty in reducing the size of the solid-state image sensing device 10, a reduction in sensitivity, and an increase in the overall power consumption of the solid-state image sensing device, occur. In addition, when the solid-state image sensing device 10 according to the related art includes the MOSFET parametric amplifier 50 (the amplifier shown in FIGS. 5A and 5B), at least two issues, that is, difficulty in reducing the power consumption or the size of the solid-state image sensing device 10 and a reduction in sensitivity, occur.

In the solid-state image sensing device 100 according to the embodiment of the present invention, amplifiers 106a to 106n (which will be described below) of the amplifying unit 106 are composed of discrete-time parametric amplifiers having a structure that is different from that of the amplifier (the MOSFET parametric amplifier 50) shown in FIGS. 5A and 5B, in order to solve the issues of the solid-state image sensing device 10 according to the related art. Before components of the solid-state image sensing device 100 are described, the principle of amplification by the amplifier included in the solid-state image sensing device 100 according to the embodiment of the present invention will be described.

### [Principle of Amplification by Amplifier Included in Solid-State Image Sensing Device 100 According to the Embodiment of the Invention]

[1] First Principle of Amplification: when Amplifier Includes Variable Capacitance Elements having Opposite Conduction Types

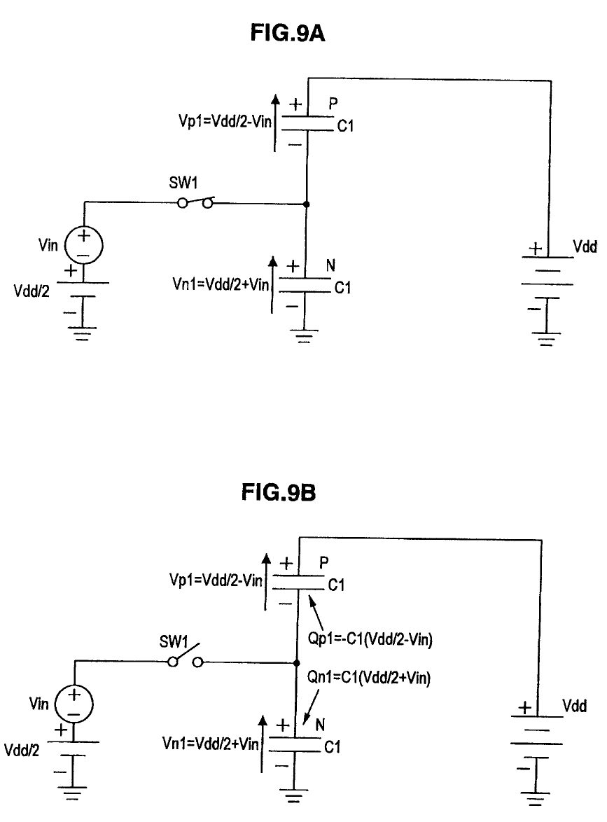

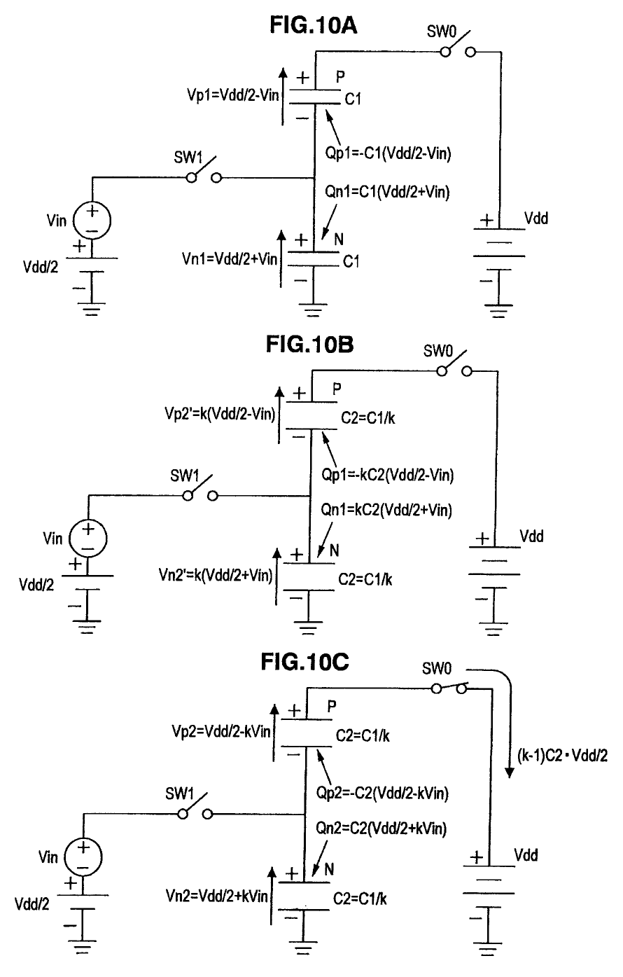

FIGS. 9A and 9B are first diagrams illustrating the first principle of amplification by the amplifier according to the embodiment of the present invention. FIGS. 10A to 10C are second diagrams illustrating the first principle of amplification by the amplifier according to the embodiment of the present invention. FIG. 9A shows the track state of the amplifier according to the embodiment of the present invention, and FIG. 9B shows the hold state of the amplifier according to the embodiment of the present invention. FIGS. 10A to 10C show the movement of charge over time in the boost state of the amplifier according to the embodiment of the present invention.

Referring to FIGS. 9A and 9B and FIGS. 10A to 10C, the amplifier according to the embodiment of the present invention includes a first variable capacitance element P having a variable capacitance and a second variable capacitance element N having a conduction type that is opposite to that of the first variable capacitance element P. A bias voltage Vdd/2 and a voltage signal Vin are input to the first variable capacitance element P and the second variable capacitance element N having a conduction type that is opposite to that of the first variable capacitance element P according to the connection state of a switch SW1. In addition, the first variable capacitance element P is connected to a power supply voltage source, and the second variable capacitance element N is connected to the ground. In FIGS. 9A and 9B and FIGS. 10A to 10C, the bias voltage has a voltage level of Vdd/2 , but the present invention is not limited thereto.

First, as shown in FIG. 9A, when the switch SW1 is turned on, the bias voltage Vdd/2 and the voltage signal Vin are input to the first variable capacitance element P and the second variable capacitance element N through the switch SW1. In this case, a voltage Vp1=Vdd/2−Vin is applied between both ends of the first variable capacitance element P, and a voltage Vn1=Vdd/2+Vin is applied between both ends of the second variable capacitance element N. As a result, charge is stored in the first variable capacitance element P and the second variable capacitance element N (track state).

When the state of the amplifier is changed from the track state shown in FIG. 9A to a state (hold state) shown in FIG. 9B in which the switch SW1 is turned off and the bias voltage Vdd/2 and the voltage signal Vin are not input, the following relationships are established in the amplifier according to the embodiment of the present invention.

(1) Charge Qp1=−C1·Vp1=−Cl(Vdd/2−Vin) immediately before the switch SW1 is turned off is held in the gate terminal (a terminal connected to the switch SW1 in FIG. 8B) of the first variable capacitance element P.

(2) Charge Qn1=C1·Vn1=C1(Vdd/2+Vin) immediately before the switch SW1 is turned off is held in the gate terminal (a terminal connected to the switch SW1 in FIG. 8B) of the second variable capacitance element N.

In this case, a charge difference between the gate terminal of the first variable capacitance element P and the gate terminal of the second variable capacitance element N is proportional to the voltage signal Vin.

Next, the boost state will be described with reference to FIGS. 10A to 10C. FIG. 10A is a diagram illustrating the hold state, similar to FIG. 9B. However, in FIG. 10A, a switch SW0, which is not shown in FIG. 9B, is additionally provided in order to describe the movement of charge in the boost state. As shown in FIGS. 10A to 10C, the switch SW0 is for controlling the connection between the first variable capacitance element P and the power supply voltage source, and is an imaginary switch for convenience of description. That is, FIG. 9B is substantially the same as FIG. 10A.

Referring to FIG. 10A, since the switch SW0 is turned off, similar to FIG. 9B, the charge Qp1=−C1·Vp1=−C1(Vdd/2−Vin) is held in the gate terminal of the first variable capacitance element P, and the charge Qn1=C1·Vn1=C1(Vdd/2+Vin) is held in the gate terminal of the second variable capacitance element N. The other conditions are the same as those shown in FIG. 9B.

As shown in FIG. 10B, it is assumed that the capacitance of the first variable capacitance element P and the capacitance of the second variable capacitance element N are reduced from the hold state shown in FIG. 10A to a value obtained by multiplying the capacitance by ‘1/k’ (that is, a changed capacitance C2=C1/k). In this case, the charge stored in the gate terminal of the first variable capacitance element P can be represented by Qp1=−C1·Vp1=−C1(Vdd/2−Vin)=−kC2(Vdd/2−Vin) and the charge stored in the gate terminal of the second variable capacitance element N can be represented by Qn1=C1·Vn1=C1(Vdd/2+Vin)=kC2(Vdd/2+Vin).

A voltage Vp2′=k(Vdd/2−Vin) is applied between both ends of the first variable capacitance element P, and is amplified by a capacitance change ratio k. Similarly, a voltage Vn2′=k(Vdd/2+Vin) is applied between both ends of the second variable capacitance element N, and is amplified by the capacitance change ratio k. The above-mentioned principle of amplification of the voltage is the same as the principle of the discrete-time parametric amplifier represented by the above-mentioned Formula 1.

Then, as shown in FIG. 10C, when the switch SW0 is turned on in the state shown in FIG. 10B, the first variable capacitance element P is connected to the power supply voltage source. In this case, the power supply voltage Vdd is applied to the first variable capacitance element P and the second variable capacitance element N, and charge Q′=(k−1)C2·Vdd/2 is moved from the first variable capacitance element P to the power supply voltage source. At the same time as the charge Q′ is moved, the amount of charge corresponding to the charge Q′ is removed from the gate terminal of the first variable capacitance element P and the gate terminal of the second variable capacitance element N. That is, charge Qp2=−C2(Vdd/2−kVin) is held in the gate terminal of the first variable capacitance element P, and charge Qn2=C2(Vdd/2+kVin) is held in the gate terminal of the second variable capacitance element N.

In this case, since the charge difference between the gate terminal of the first variable capacitance element P and the gate terminal of the second variable capacitance element N is held, the voltage Vp2 applied between both ends of the first variable capacitance element P is represented by Formula 2 given below. In addition, the voltage Vn2 applied between both ends of the second variable capacitance element N is represented by Formula 3 given below.

Vp2=(vdd/2)−k·Vin=Vbias−k·Vin [Formula 2]

Vn2=(Vdd/2)+k·Vin=Vbias+k·Vin [Formula 3]

In the amplifier according to the embodiment of the present invention, the voltage signal Vin is amplified by k times (capacitance change ratio), but the bias voltage Vdd/2=Vbias is not amplified, unlike the MOSFET parametric amplifier 50 according to the related art in which both the bias voltage and the voltage signal are amplified while overlapping each other. Therefore, in the amplifier according to the embodiment of the present invention, unlike the MOSFET parametric amplifier 50 according to the related art, the level of the output voltage is not excessively high, and the above-mentioned two issues of the MOSFET parametric amplifier 50 according to the related art are less likely to occur. As a result, it is possible to reduce the power consumption and the size of a circuit.

In the above-mentioned structure, the gate terminal of the first variable capacitance element P and the gate terminal of the second variable capacitance element N are connected to the switch SW1 in FIGS. 9A and 9B and FIGS. 10A to 10C. However, the first principle of amplification by the amplifier according to the embodiment of the present invention is not limited thereto. For example, in FIGS. 9A and 9B and FIG. 10A to 10C, the source terminal and the drain terminal of the first variable capacitance element P and the source terminal and the drain terminal of the second variable capacitance element N may be connected to the switch SW1.

When the source terminal and the drain terminal of the first variable capacitance element P and the source terminal and the drain terminal of the second variable capacitance element N are connected to the switch SW1 in FIGS. 9A and 9B and FIG. 10A to 10C, for example, the first variable capacitance element P and the second variable capacitance element N may be replaced with each other. When the amplifier according to the embodiment of the present invention has the above-mentioned structure, the two issues of the MOSFET parametric amplifier 50 according to the related art are less likely to occur, and it is possible to reduce the power consumption and the size of a circuit. Of course, the amplifier according to the embodiment of the present invention is not limited to the structure in which the amplifier has the gate terminal, the source terminal, and the drain terminal.

[2] Second Principle of Amplification: When Amplifier Includes Variable Capacitance Elements having the Same Conduction Type

In the above-mentioned structure, the amplifier according to the embodiment of the present invention includes variable capacitance elements having opposite conduction types, and the principle of amplification by the amplifier has been described. However, the present invention is not limited thereto, but the amplifiers included in the solid-state image sensing device according to the embodiment of the present invention each may include variable capacitance elements having the same conduction type.

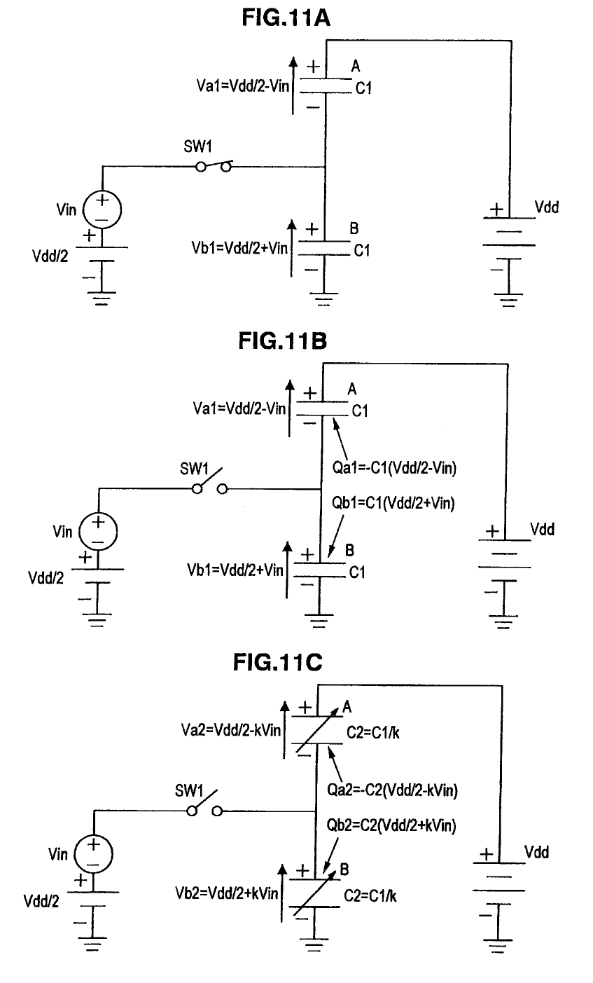

FIGS. 11A to 11C are diagrams illustrating the second principle of amplification by the amplifier according to the embodiment of the present invention. FIG. 11A shows the track state of the amplifier according to the embodiment of the present invention, and FIG. 11B shows the hold state of the amplifier according to the embodiment of the present invention. FIG. 11C shows the boost state of the amplifier according to the embodiment of the present invention.

Referring to FIGS. 11A to 11C, the amplifier according to the embodiment of the present invention includes a first variable capacitance element A having a variable capacitance and a second variable capacitance element B having the same conduction type as the first variable capacitance element A. The bias voltage Vdd/2 and the voltage signal Vin are input to the first variable capacitance element A and the second variable capacitance element B according to the connection state of the switch SW1. In addition, the first variable capacitance element A is connected to the power supply voltage source, and the second variable capacitance element B is connected to the ground. In FIGS. 11A to 11C, the bias voltage has a voltage level of Vdd/2 , but the present invention is not limited thereto.

First, as shown in FIG. 11A, in the track state, when the switch SW1 is turned on, the bias voltage Vdd/2 and the voltage signal Vin are input through the switch SW1. Therefore, a potential difference Va1 between both ends of the first variable capacitance element A is Vdd/2−Vin, and a potential difference Vb between both ends of the second variable capacitance element B is Vdd/2+Vin. As a result, charge is stored in the first variable capacitance element A and the second variable capacitance element B.

Then, as shown in FIG. 11B, in the hold state, when the switch SW1 is turned off in the track state, the input of the bias voltage Vdd/2 and the voltage signal Vin stops. In the hold state, the following relationships are established.

(1) Charge Qa1=−C1·Va1=−C1(Vdd/2−Vin) immediately before the switch SW1 is turned off is held in the lower end of the first variable capacitance element A (a terminal connected to the switch SW1 in FIG. 11B).

(2) Charge Qb1=C1·Vb1=C1(Vdd/2+Vin) immediately before the switch SW1 is turned off is held in the upper end of the second variable capacitance element A (a terminal connected to the switch SW1 in FIG. 11B).

The sum Qtotal_{Hold} of the charges held in the lower end of the first variable capacitance element A and the upper end of the second variable capacitance element B is 2·C1·Vin. Therefore, this is equivalent to the structure in which the input signal Vin is input to a capacitance element having a capacitance that is two times the capacitance C1.

Then, as shown in FIG. 11C, in the boost state, each of the capacitance of the first variable capacitance element A and the capacitance of the second variable capacitance element B is reduced from C1 to C2(C1>C2) which is 1/k times the value of C1. That is, the reduced capacitance of each of the first variable capacitance element A and the second variable capacitance element B is C2=C1/k.

In this case, charge Q′=(k−1)C2·Vdd/2 is moved from the first variable capacitance element A to the power supply voltage source, and the amount of charge corresponding to the charge Q′ is removed from the lower end of the first variable capacitance element A and the upper end of the second variable capacitance element B. Therefore, charge Qa2=−C2(Vdd/2−kVin) is held in the lower end of the first variable capacitance element A, and charge Qb2=−C2(Vdd/2+kVin) is held in the upper end of the second variable capacitance element B.

Therefore, in the boost state, a potential difference Va2 between both ends of the first variable capacitance element A is Vdd/2−kVin, and a potential difference Vb2 between both ends of the second variable capacitance element B is Vdd/2+kvin. The sum Qtotal_{Boost} of the charges held in the lower end of the first variable capacitance element A and the upper end of the second variable capacitance element B in the boost state is 2·C1·Vin=Qtotal_{Hold}. Therefore, charge is held even in the boost state.

As shown in FIGS. 11A to 11C, similar to the amplifier described in the first principle of amplification, the amplifier according to the embodiment of the present invention can amplify the input voltage signal Vin by k times (capacitance change ratio) while holding the level of the bias voltage Vdd/2=Vbias. Therefore, when the amplifier according to the embodiment of the present invention performs amplification using the second principle of amplification, similar to when performing amplification using the first principle of amplification, the level of an output voltage is not excessively high, unlike the MOSFET parametric amplifier 50 according to the related art. Therefore, in the amplifier according to the embodiment of the present invention, the above-mentioned two issues of the MOSFET parametric amplifier 50 according to the related art are less likely to occur, and it is possible to reduce the power consumption and the size of a circuit.

Further, the second principle of amplification by the amplifier according to the embodiment of the present invention can be applied to the structure in which CMOSs are used as the variable capacitance elements of the amplifier or the structure in which the variable capacitance elements have the same conduction type. That is, although the first and second principles of amplification have been separately described, they are substantially the same.

The solid-state image sensing device 100 according to the embodiment of the present invention includes, for example, the amplifiers each including variable capacitance elements having opposite conduction types or the amplifiers each including variable capacitance elements having the same conduction type. As described above, the amplifier according to the embodiment of the present invention amplifies the input voltage signal Vin by k times (capacitance change ratio) while holding the level of the bias voltage Vbias. Therefore, the above-mentioned two issues of the MOSFET parametric amplifier 50 according to the related art (difficulty in reducing the power consumption or the size of a circuit and the generation of noise) are less likely to occur. In addition, the solid-state image sensing device 100 according to the embodiment of the present invention can amplify the input voltage signal Vin without using an operational amplifier. Therefore, the above-mentioned three issues of the amplifier according to the related art shown in FIG. 2 (difficulty in reducing the size of a circuit, the generation of noise, and large power consumption) do not arise.

Therefore, in the solid-state image sensing device 100 according to the embodiment of the present invention, even when the number of amplifiers is increased with an increase in the resolution of the solid-state image sensing device 100, the above-mentioned issues of the solid-state image sensing device 10 according to the related art are less likely to occur. As a result, the solid-state image sensing device 100 according to the embodiment of the present invention can prevent a reduction in the sensitivity thereof and reduce power consumption.

Next, components of the solid-state image sensing device 100 according to the embodiment of the present invention will be described with reference to FIG. 8 again. The pixel unit 102 includes pixels 102a1 to 102mn arranged in a matrix. In addition, the pixels of the pixel unit 102 each include a photodiode (photoelectric conversion element) that generates a pixel signal corresponding to inputted light, and output the pixel signals to signal lines 112a to 112m connected thereto in response to selection signals transmitted from the row driving circuit 104.

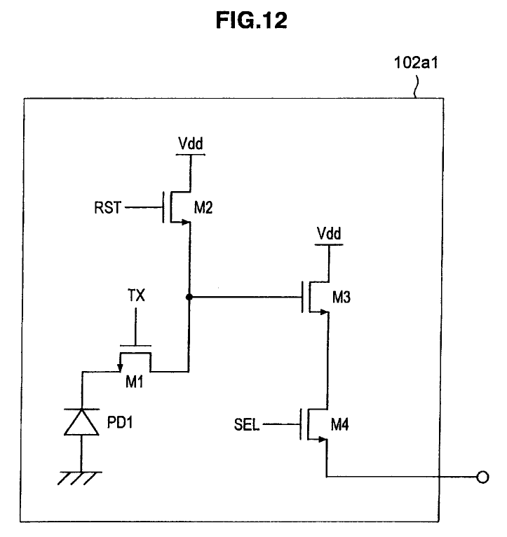

FIG. 12 is a diagram illustrating an example of the structure of the pixel included in the solid-state image sensing device 100 according to the embodiment of the present invention. FIG. 12 shows the pixel 102a 1 among the pixels of the pixel unit 102, and the other pixels 102a 2 to 102mn have the same structure as the pixel 102a1.

Referring to FIG. 12, the pixel 102a1 includes a photodiode PD1, a transistor M1, a transistor M2, a transistor M3, and a transistor M4. A signal TX, a signal RST, and a signal SEL shown in FIG. 12 are output from, for example, the row driving circuit 104. In addition, the voltage signal Vdd shown in FIG. 12 is supplied from, for example, an imaging apparatus (not shown) including the solid-state image sensing device 100, but the present invention is not limited thereto.

The photodiode PD1 is a photoelectric conversion element that generates a pixel signal corresponding to inputted light. The transistor M1 is a charge transmission transistor that is provided in order to improve the sensitivity of the pixel 102a1. For example, when a high-level signal TX is supplied, the transistor M1 transmits the pixel signal. The transistor M2 is a switch that resets the signal input to the gate of the transistor M3. For example, when the signal RST is at a high level, the transistor M2 resets the gate of the transistor M3 to a predetermined voltage level. The transistor M3 is a so-called source follower circuit, and outputs a signal from the source thereof in response to the signal input to the gate. In this case, the transistor M3 resets a signal using relatively small source impedance. As a result, it is possible to prevent the attenuation of the pixel signal generated by the photodiode PD1, and a signal (that is, the pixel signal) corresponding to the pixel signal is output from the source of the transistor M3. Therefore, the pixel 102a1 can improve the S/N ratio of the signal. The transistor M4 is a switch that controls the output of signals from the pixel 102a1. For example, when the signal SEL (selection signal) is at a high level, the transistor M3 (source follower circuit) obtains a bias current, and a signal is output to a signal line connected to the transistor M4.

The pixels of the pixel unit 102 having the structure shown in FIG. 12 according to the embodiment of the present invention can selectively output the pixel signals generated by the photodiodes PD1. The structure of the pixel according to the embodiment of the present invention is not limited to that shown in FIG. 12, but the pixel may have various structures. For example, a highly-integrated pixel including one photodiode and three transistors or 1.75 transistors may be used.

The row driving circuit 104 selectively supplies the signal TX, the signal RST, and the signal SEL (selection signal) to each of the pixels of the pixel unit 102 to control the pixel that outputs the pixel signal. For example, when the row driving circuit 104 supplies the signal TX, the signal RST, and the signal SEL to each row of pixels of the pixel unit 102, pixel signals corresponding to the pixels supplied with the signal TX, the signal RST, and the signal SEL among the pixels connected to each signal line are transmitted to each signal line.

The amplifying unit 106 includes an amplifier 106a connected to the signal line 112a , an amplifier 106b connected to the signal line 112b , . . . , an amplifier 106n connected to the signal line 112m . The amplifiers 106a to 106n of the amplifying unit 106 each amplify an input pixel signal using the above-mentioned principle of amplification of the amplifier according to the embodiment of the present invention. Next, the structure of the amplifier according to the embodiment of the present invention will be described in detail. In the following description, it is assumed that an input voltage signal Vinput applied to the amplifier is an overlap signal of the bias voltage Vbias and the pixel signal Vin.

### [Examples of Structure of Amplifier According to the Embodiment of the Invention]

### [1] First Structural Example of Amplifier

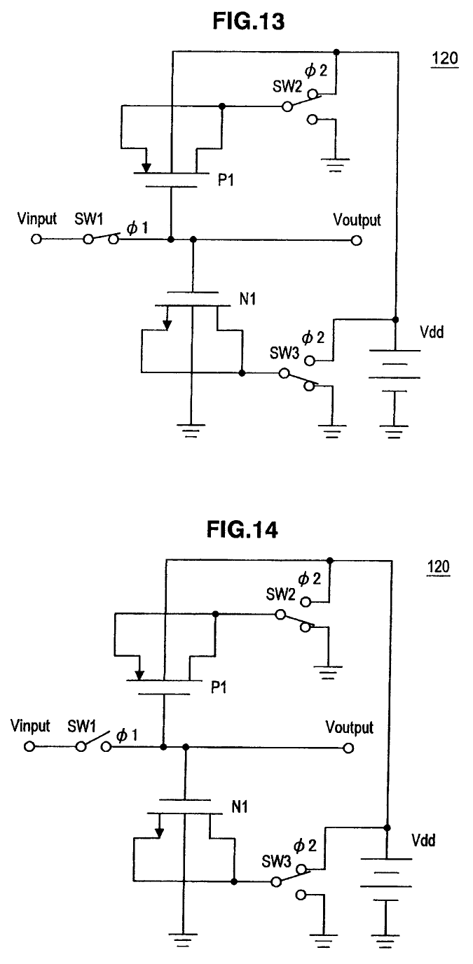

FIG. 13 is a first diagram illustrating an amplifier 120 according to a first structural example provided in the solid-state image sensing device 100 according to the embodiment of the present invention, and shows the track state of the amplifier 120. FIG. 14 is a second diagram illustrating the amplifier 120 according to the first structural example provided in the solid-state image sensing device 100 according to the embodiment of the present invention, and shows the boost state of the amplifier 120. In FIGS. 13 and 14, a power supply voltage source is provided in the amplifier 120, but the present invention is not limited thereto. For example, the power supply voltage source may be provided in the solid-state image sensing device 100, or it may be provided in an external apparatus, such as an imaging apparatus including the solid-state image sensing device 100. Various amplifiers according to the embodiment of the present invention will be described in the same non-limiting manner.

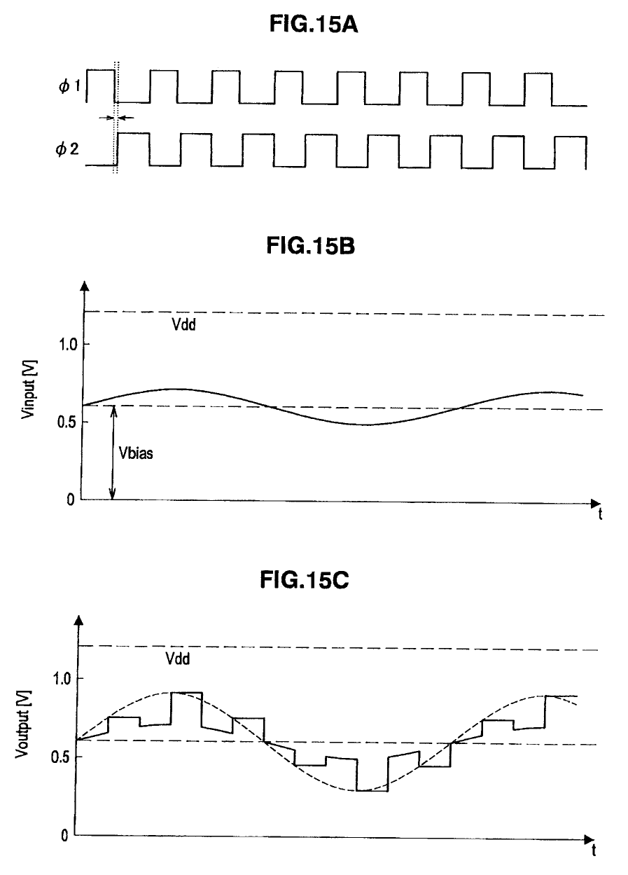

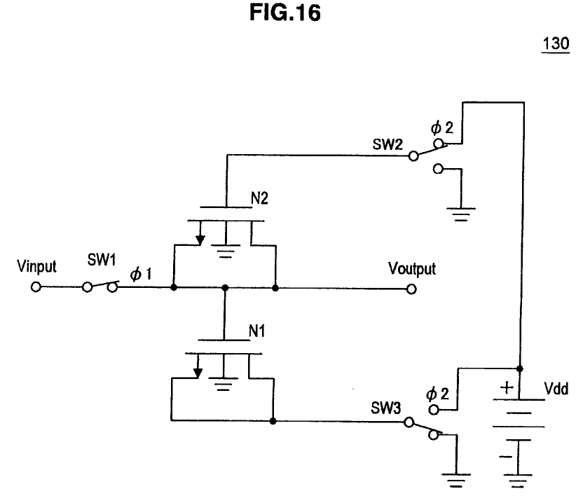

FIGS. 15A to 15C are third diagrams illustrating the amplifier 120 according to the first structural example provided in the solid-state image sensing device 100 according to the embodiment of the present invention. FIG. 15A shows control clock signals that control switches SW1, SW2, and SW3 of the amplifier 120 shown in FIGS. 13 and 14. For example, the control clock signals can be generated by the row driving circuit, but the present invention is not limited thereto. For example, the control clock signals may be supplied from an imaging apparatus (not shown) including the solid-state image sensing device 100. FIG. 15B shows an example of the input voltage signal Vinput input to the amplifier 120, and FIG. 15C shows an example of the output voltage signal Voutput output from the amplifier 120. Of course, the waveform of the input voltage signal Vinput according to the embodiment of the present invention is not limited to that shown in FIG. 15B.

Referring to FIGS. 13 and 14, the amplifier 120 is composed of a CMOS that includes a p-MOS varactor P1 and an n-MOS varactor N1. The capacitances of the p-MOS varactor P1 and the n-MOS varactor N1 vary depending on whether there is an inversion layer, similar to the MOSFET shown in FIGS. 4A and 4B.

A bias voltage Vbias and a pixel signal Vin are input to the gate terminals of the p-MOS varactor P1 and the n-MOS varactor N1 according to the connection state of the switch SW1. The source and drain terminals of the p-MOS varactor P1 are connected to the power supply voltage source or the ground according to the connection state of the switch SW2. In addition, the source and drain terminals of the n-MOS varactor N1 are connected to the power supply voltage source or the ground according to the connection state of the switch SW3. In this case, the p-MOS varactor P1 and the n-MOS varactor N1 have opposite conduction types. Therefore, when the switch SW2 is connected to the power supply voltage source, the switch SW3 is connected to the ground, and when the switch SW2 is connected to the ground, the switch SW3 is connected to the power supply voltage source, in order to match the increase and decrease rates of the capacitances of the p-MOS varactor P1 and the n-MOS varactor N1.

When a control signal having a first level is supplied, the source and drain terminals of the p-MOS varactor P1 and the source and drain terminals of the n-MOS varactor N1 are connected to the ground. In addition, when a control signal having a second level that is higher than the first level is supplied, the source and drain terminals of the p-MOS varactor P1 and the source and drain terminals of the n-MOS varactor N1 are connected to the power supply voltage. Therefore, the voltage levels of the control signals applied to the source and drain terminals of the p-MOS varactor P1 and the source and drain terminals of the n-MOS varactor N1 are different from each other.

In FIGS. 13 and 14, the switches SW2 and SW3 are controlled to selectively connect the p-MOS varactor P1 and the n-MOS varactor N1 to the power supply voltage source or the ground, such that the control signal having the first level or the control signal having the second level is supplied. However, the present invention is not limited thereto. For example, the solid-state image sensing device according to the embodiment of the present invention may include a control signal generating unit (not shown) that selectively outputs the control signal having the first level or the control signal having the second level, and the control signal output from the control signal generating unit (not shown) may be input to the p-MOS varactor P1 and the n-MOS varactor N1. In addition, the control signal generating unit (not shown) may be provided in, for example, an external apparatus, such as an imaging apparatus including the solid-state image sensing device according to the embodiment of the present invention.

The switch SW1 (input unit) is turned on or off in synchronization with a clock signal φ1 shown in FIG. 15A. For example, when the clock signal φ1 is at a high level, the switch SW1 is turned on, and the bias voltage Vbias and the pixel signal Vin are input to the gate terminals of the p-MOS varactor P1 and the n-MOS varactor N1. In addition, for example, when the clock signal φ1 is at a low level, the switch SW1 is turned off to control the input of the bias voltage Vbias and the pixel signal Vin to the gate terminals of the p-MOS varactor P1 and the n-MOS varactor N1. The relationship between the clock signal φ1 and the switch SW1 is not limited to the above. For example, when the clock signal φ1 is at the low level, the switch SW1 may be turned on. Next, various amplifiers according to the embodiment of the present invention will be described. In the following description, the relationship between a clock signal and a switch is not particularly limited, similar to the relationship between the clock signal φ1 and the switch SW1.

The switch SW2 is turned on or off in synchronization with the clock signal φ2 shown in FIG. 15A. When the clock signal φ2 is at a high level, the switch SW2 is connected to the ground. When the clock signal φ2 is at a low level, the switch SW2 is connected to the power supply voltage source. The switch SW3 is turned on or off in synchronization with the clock signal φ2. When the clock signal φ2 is at the high level, the switch SW3 is connected to the power supply voltage source. When the clock signal φ2 is at the low level, the switch SW3 is connected to the ground. In this case, as shown in FIG. 15A, the clock signal φ1 and the clock signal φ2 are input such that the phases thereof do not overlap each other. When the clock signal φ1 and the clock signal φ2 are input such that the phases thereof do not overlap each other, the track state, the hold state, and the boost state are obtained in the amplifier 120.

Referring to FIG. 13, in the track state, the switch SW1 is turned on in synchronization with the clock signal φ1, and the input voltage signal Vinput is input to the gate terminals of the p-MOS varactor P1 and the n-MOS varactor N1. When the switch SW2 is connected to the power supply voltage source in synchronization with the clock signal φ2 and the switch SW3 is connected to the ground in synchronization with the clock signal φ2, the capacitances of the p-MOS varactor P1 and the n-MOS varactor N1 increase. The voltages of the gate terminals of the p-MOS varactor P1 and the n-MOS varactor N1 vary depending on the input voltage signal Vinput, and a charge corresponding to the input voltage signal Vinput is stored in the p-MOS varactor P1 and the n-MOS varactor N1.

Then, referring to FIG. 14, in the boost state, the switch SW1 is turned off in synchronization with the clock signal φ1, and the input voltage signal Vinput is not input to the gate terminals of the p-MOS varactor P1 and the n-MOS varactor N1. When the switch SW2 is connected to the ground in synchronization with the clock signal φ2 and the switch SW3 is connected to the power supply voltage source in synchronization with the clock signal φ2, the capacitances of the p-MOS varactor P1 and the n-MOS varactor N1 decrease. In this case, since charge is held in the gate terminals of the p-MOS varactor P1 and the n-MOS varactor N 1, the capacitances vary as represented by Formulae 2 and 3, and the pixel signal Vin is amplified by the capacitance change ratio while the level of the bias voltage Vbias is maintained.

Therefore, as shown in FIG. 15C, the output voltage signal Voutput of the amplifier 120 has a waveform in which the level of the bias voltage Vbias is maintained and the pixel signal Vin is amplified by the capacitance change ratio, for the input voltage signal Vinput. Since the level of the output voltage signal Voutput is lower than that of the power supply voltage Vdd (the control signal having the second level), no distortion occurs in the output voltage, unlike the MOSFET parametric amplifier 50 according to the related art. Although not shown in FIGS. 13 and 14, during a period from the falling edge of the clock signal φ1 to the rising edge of the clock signal φ2 shown in FIG. 15A, the amplifier 120 is changed from the track state shown in FIG. 13 to the boost state shown in FIG. 14 through the hold state.

As described above, the amplifier 120 according to the first structural example of the embodiment of the present invention can output the output voltage signal Voutput having a waveform in which the level of the bias voltage Vbias is maintained and the pixel signal Vin is amplified by the capacitance change ratio, for the input voltage signal Vinput. Therefore, the level of the output voltage signal-Voutput is not excessively high. As a result, in a circuit including the amplifier 120, it is not necessary to take a special measure for the output voltage signal Voutput of the amplifier 120, and it is possible to reduce the power consumption and the size of the circuit. In addition, the amplifier 120 can significantly reduce the probability that the level of the output voltage signal Voutput is higher than that of the power supply voltage Vdd (the control signal having the second level). Therefore, no distortion occurs in the output voltage signal Voutput, and it is possible to obtain a desired output voltage signal Voutput without noise.

### <Modifications of Amplifier 120>

In the amplifier 120 shown in FIGS. 13 and 14, the gate terminals of the p-MOS varactor P1 and the n-MOS varactor N1 are connected to the switch SW1, and the source and drain terminals of the p-MOS varactor P1 are connected to the switch SW2. In addition, the source and drain terminals of the n-MOS varactor N 1 are connected to the switch SW3. However, the structure of the amplifier according to the first structural example of the embodiment of the present invention is not limited thereto. For example, in the amplifier according to the first structural example, the source and drain terminals of the p-MOS varactor P1 and the source and drain terminals of the n-MOS varactor N1 may be connected to the switch SW1, the gate terminal of the n-MOS varactor N1 may be connected to the switch SW2, and the gate terminal of the p-MOS varactor P1 may be connected to the switch SW3.

In this case, the p-MOS varactor P1 and the n-MOS varactor N1 have opposite conduction types. Therefore, in the amplifier according to the first structural example, similar to the amplifier 120, when the switch SW2 is connected to the power supply voltage source, the switch SW3 is connected to the ground, in order to match the increase and decrease rates of the capacitances of the varactors. In addition, in the amplifier according to the first structural example, similar to the amplifier 120, when the switch SW2 is connected to the ground, the switch SW3 is connected to the power supply voltage source.

In the above-mentioned structure, the amplifier according to the first structural example can also obtain the track state, the hold state, and the boost state, similar to the amplifier 120. Therefore, the capacitances vary as represented by Formulae 2 and 3, and the pixel signal Vin can be amplified by the capacitance change ratio while the level of the bias voltage Vbias is maintained.

### [2] Second Structural Example of Amplifier

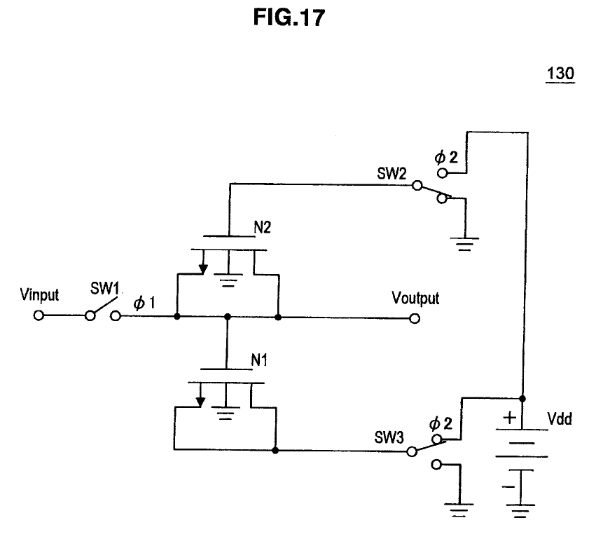

FIG. 16 is a first diagram illustrating an amplifier 130 according to a second structural example provided in the solid-state image sensing device 100 according to the embodiment of the present invention, and shows the track state of the amplifier 130. FIG. 17 is a second diagram illustrating the amplifier 130 according to the second structural example provided in the solid-state image sensing device 100 according to the embodiment of the present invention, and shows the boost state of the amplifier 130.

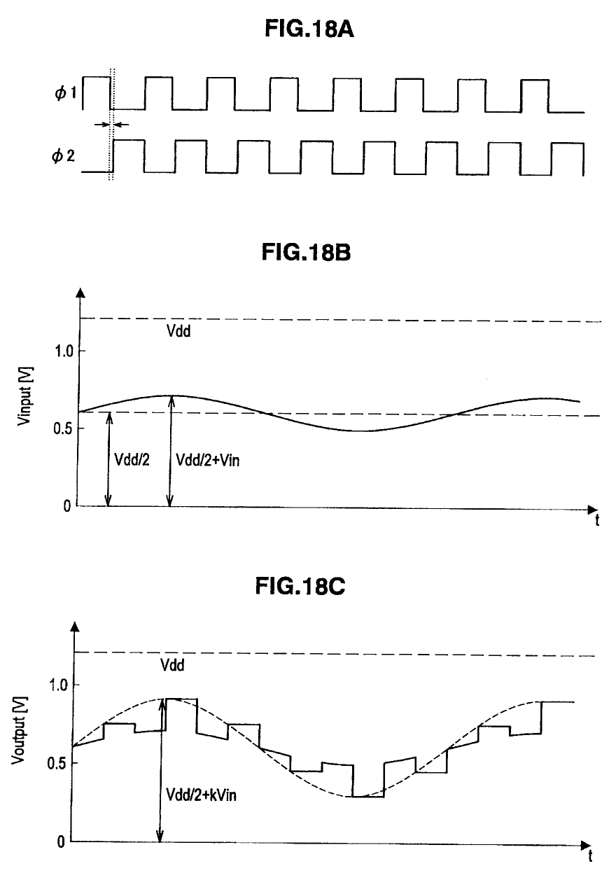

FIGS. 18A to 18C are third diagrams illustrating the amplifier 130 according to the second structural example provided in the solid-state image sensing device 100 according to the embodiment of the present invention. FIG. 18A shows control clock signals that control switches SW1, SW2, and SW3 of the amplifier 130 shown in FIGS. 16 and 17. FIG. 18B shows an example of the input voltage signal Vinput input to the amplifier 130, and FIG. 18C shows an example of the output voltage signal Voutput output from the amplifier 130. In FIGS. 16 to 18C, the bias voltage Vbias has a voltage level of Vdd/2 , but the bias voltage is not limited thereto.

Referring to FIGS. 16 and 17, the amplifier 130 includes n-MOS varactors N1 and N2. The capacitances of the n-MOS varactors N1 and N2 vary depending on whether there is an inversion layer, similar to the MOSFET shown in FIGS. 4A and 4B. It is preferable that the width and length of the gate terminal of each of the n-MOS varactors N1 and N2 included in the amplifier 130 be substantially equal to each other (that is, a production tolerance can be allowed).

The input voltage signal Vinput is input to the gate terminal of the n-MOS varactor N1 and the source and drain terminals of the n-MOS varactor N2 according to the connection state of the switch SW1.

In addition, the source and drain terminals of the n-MOS varactor N1 are connected to the power supply voltage source or the ground according to the connection state of the switch SW3, and the gate terminal of the n-MOS varactor N2 is connected to the power supply voltage source or the ground according to the connection state of the switch SW2. The n-MOS varactors N1 and N2 have the same conduction type, but different terminals are connected to the switch SW1. Therefore, when the switch SW2 is connected to the power supply voltage source, the switch SW3 is connected to the ground, and when the switch SW2 is connected to the ground, the switch SW3 is connected to the power supply voltage source, in order to match the increase and decrease rates of the capacitances of the n-MOS varactors N1 and N2. Control signals having different voltage levels (a control signal having a first level and a control signal having a second level) are input to the source and drain terminals of the n-MOS varactor N1 and the gate terminal of the n-MOS varactor N2.

The switch SW1 is turned on or off in synchronization with a clock signal φ1 shown in FIG. 18A. For example, when the clock signal φ1 is at a high level, the switch SW1 is turned on, and the input voltage signal Vinput is input to the gate terminal of the n-MOS varactor N1 and the source and drain terminals of the n-MOS varactor N2. In addition, for example, when the clock signal φ1 is at a low level, the switch SW1 is turned off to control the input of the input voltage signal Vinput to the gate terminal of the n-MOS varactor N1 and the source and drain terminals of the n-MOS varactor N2.

The switch SW2 is turned on or off in synchronization with a clock signal φ2 shown in FIG. 18A. When the clock signal φ2 is at a high level, the switch SW2 is connected to the ground. When the clock signal φ2 is at a low level, the switch SW2 is connected to the power supply voltage source. The switch SW3 is turned on or off in synchronization with the clock signal φ2. When the clock signal φ2 is at the high level, the switch SW3 is connected to the power supply voltage source. When the clock signal φ2 is at the low level, the switch SW3 is connected to the ground. In this case, as shown in FIG. 18A, the clock signal φ1 and the clock signal φ2 are input such that the phases thereof do not overlap each other. The reason is to obtain the hold state, similar to the amplifier 120 according to the first structural example.

In the track state of the amplifier 130 shown in FIG. 16, for example, when the clock signal φ1 is at the high level, the switch SW1 is turned on, and the input voltage signal Vinput is input to the gate terminal of the n-MOS varactor N1 and the source and drain terminals of the n-MOS varactor N2.

In addition, for example, when the clock signal φ2 is at the low level, the switch SW2 is connected to the power supply voltage source. For example, when the clock signal φ2 is at the low level, the switch SW3 is connected to the ground. In this case, an inversion layer is generated on a semiconductor interface immediately below the gate terminal of each of the n-MOS varactors N1 and N2, and the capacitances of the varactors increase. Therefore, a charge corresponding to the input voltage signal Vinput is stored in each of the n-MOS varactors N1 and N2.

In the boost state of the amplifier 130 shown in FIG. 17, for example, when the clock signal φ1 is at the low level, the switch SW1 is turned off, and the input of the input voltage signal Vinput stops.

For example, when the clock signal φ2 is at the high level, the switch′ SW2 is connected to the ground. For example, when the clock signal φ2 is at the high level, the switch SW3 is connected to the power supply voltage source. In this case, the inversion layer generated on the semiconductor interface immediately below the gate terminal of each of the n-MOS varactors N1 and N2 is removed, and the capacitances of the varactors decrease. In addition, since charge is held in the gate terminal of the n-MOS varactor N1 and the source and drain terminals of the n-MOS varactor N2, the pixel signal Vin is amplified by the capacitance change ratio while the level of the bias voltage Vdd/2 is maintained, due to the variation in the capacitances.

As shown in FIG. 18C, the output voltage signal Voutput of the amplifier 130 according to the second structural example of the embodiment of the present invention has a waveform in which the level of the bias voltage Vbias is maintained and the pixel signal Vin is amplified by the capacitance change ratio, for the input voltage signal Vinput. Since the level of the output voltage signal Voutput is lower than that of the power supply voltage Vdd (the control signal having the second level), no distortion occurs in an output voltage, unlike the MOSFET parametric amplifier 50 according to the related art.

Therefore, the amplifier 130 according to the second structural example of the embodiment of the present invention can output the output voltage signal Voutput having a waveform in which the level of the bias voltage Vbias is maintained and the pixel signal Vin is amplified by the capacitance change ratio, for the input voltage signal Vinput. Therefore, the level of the output voltage signal Voutput is not excessively high. As a result, in a circuit including the amplifier 130, it is not necessary to take a special measure for the output voltage signal Voutput of the amplifier 130, and it is possible to reduce the power consumption and the size of the circuit. In addition, the amplifier 130 can significantly reduce the probability that the level of the output voltage signal Voutput is higher than that of the power supply voltage Vdd (the control signal having the second level). Therefore, no distortion occurs in the output voltage signal Voutput, and it is possible to obtain a desired output voltage signal Voutput without noise.

### [3] Third Structural Example of Amplifier

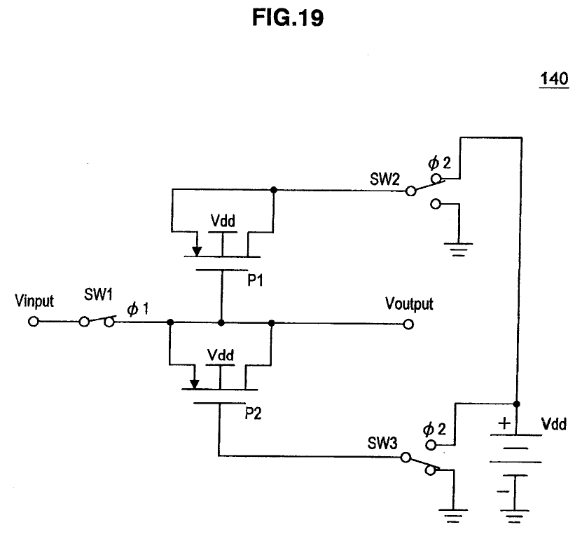

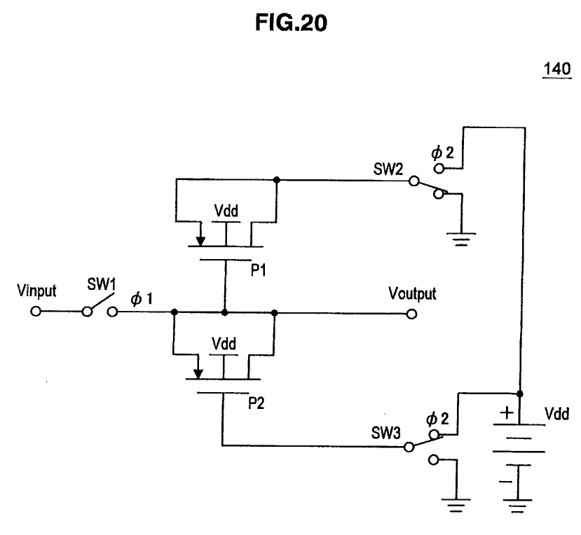

FIG. 19 is a first diagram illustrating an amplifier 140 according to a third structural example provided in the solid-state image sensing device 100 according to the embodiment of the present invention, and shows the track state of the amplifier 140. FIG. 20 is a second diagram illustrating the amplifier 140 according to the third structural example provided in the solid-state image sensing device 100 according to the embodiment of the present invention, and shows the boost state of the amplifier 140.

Referring to FIGS. 19 and 20, the amplifier 140 according to the third structural example includes p-MOS varactors P1 and P2. The capacitances of the p-MOS varactors P1 and P2 vary depending on whether there is an inversion layer, similar to the MOSFET shown in FIGS. 4A and 4B. It is preferable that the width and length of the gate terminal of each of the p-MOS varactors P1 and P2 included in the amplifier 140 be substantially equal to each other (that is, a production tolerance can be allowed).

The input voltage signal Vinput is input to the gate terminal of the p-MOS varactor P1 and the source and drain terminals of the p-MOS varactor P2 according to the connection state of the switch SW1. In the following description, it is assumed that the input voltage signal Vinput input to the amplifier 140 is the same as that shown in FIG. 18B. In addition, in the following description, it is assumed that, similar to the amplifier 130 according to the second structural example, the clock signals shown in FIG. 18A are input to switches SW1, SW2, and SW3 of the amplifier 140.

The source and drain terminals of the p-MOS varactor P1 are connected to the power supply voltage source or the ground according to the connection state of the switch SW2, and the gate terminal of the p-MOS varactor P2 is connected to the power supply voltage source or the ground according to the connection state of the switch SW3. The p-MOS varactors P1 and P2 have the same conduction type, but different terminals are connected to the switch SW1. Therefore, when the switch SW2 is connected to the power supply voltage source, the switch SW3 is connected to the ground, and when the switch SW2 is connected to the ground, the switch SW3 is connected to the power supply voltage source, in order to match the increase and decrease rates of the capacitances of the p-MOS varactors P1 and P2. Control signals having different voltage levels (a control signal having a first level and a control signal having a second level) are input to the source and drain terminals of the p-MOS varactor P1 and the gate terminal of the p-MOS varactor P2.

In the track state of the amplifier 140 shown in FIG. 19, for example, when the clock signal φ1 is at a high level, the switch SW1 is turned on, and the input voltage signal Vinput is input to the gate terminal of the p-MOS varactor P1 and the source and drain terminals of the p-MOS varactor P2.

In addition, for example, when the clock signal φ2 is at a low level, the switch SW2 is connected to the power supply voltage source. For example, when the clock signal φ2 is at the low level, the switch SW3 is connected to the ground. In this case, an inversion layer is generated on a semiconductor interface immediately below the gate terminal of each of the p-MOS varactors P1 and P2, and the capacitances of the varactors increase. Therefore, a charge corresponding to the input voltage signal Vinput is stored in each of the p-MOS varactors P1 and P2.

In the boost state of the amplifier 140 shown in FIG. 20, for example, when the clock signal φ1 is at a low level, the switch SW1 is turned off, and the input of the input voltage signal Vinput stops.

For example, when the clock signal φ2 is at a high level, the switch SW2 is connected to the ground. For example, when the clock signal φ2 is at the high level, the switch SW3 is connected to the power supply voltage source. In this case, the inversion layer generated on the semiconductor interface immediately below the gate terminal of each of the p-MOS varactors P1 and P2 is removed, and the capacitances of the varactors decrease. In addition, since charge is held in the gate terminal of the p-MOS varactor P1 and the source and drain terminals of the p-MOS varactor P2, the pixel signal Vin-is amplified by the capacitance change ratio while the level of the bias voltage Vdd/2 is maintained, due to the variation in the capacitances. That is, since the amplifier 140 includes variable capacitance elements having a conduction type that is opposite to that of the variable capacitance elements of the amplifier 130 according to the second structural example, the amplifier 140 has the same function as the amplifier 130 except for the connection of the variable capacitance elements.

Therefore, the amplifier 140 according to the third structural example of the embodiment of the present invention can output the output voltage signal Voutput having a waveform in which the level of the bias voltage Vbias is maintained and the pixel signal Vin is amplified by the capacitance change ratio, for the input voltage signal Vinput. Therefore, the level of the output voltage signal Voutput is not excessively high. As a result, in a circuit including the amplifier 140, it is not necessary to take a special measure for the output voltage signal Voutput of the amplifier 140, and it is possible to reduce the power consumption and the size of the circuit. In addition, the amplifier 140 can significantly reduce the probability that the level of the output voltage signal Voutput is higher than that of the power supply voltage Vdd (the control signal having the second level). Therefore, no distortion occurs in the output voltage signal Voutput, and it is possible to obtain a desired output voltage signal Voutput without noise.

### [4] Fourth Structural Example of Amplifier

As described in the first principle of amplification by the amplifier according to the embodiment of the present invention, in the amplifier according to the embodiment of the present invention, the same amount of charge is offset in one terminal of the first variable capacitance element P and one terminal of the second variable capacitance element N that is electrically connected to the one terminal of the first variable capacitance element P. As a result, it is possible to amplify the pixel signal by the capacitance change ratio while maintaining the level of the bias voltage. However, for example, when a capacitance difference ΔC between the capacitance of the first variable capacitance element P and the capacitance of the second variable capacitance element N occurs due to an unexpected situation, such as a process variation in the first variable capacitance element P and the second variable capacitance element N, it is difficult to obtain a desired effect. The reason will be described briefly below with reference to FIGS. 9A, 9B, and 10A to 10C.

For example, when there is a capacitance difference ΔC between the capacitance of the first variable capacitance element P and the capacitance of the second variable capacitance element N, in FIG. 9B, charge Qp1=−C1(Vdd/2−Vin) is stored in the gate terminal of the first variable capacitance element P. In addition, in FIG. 9B, charge Qn1=(C1+ΔC)·(Vdd/2+Vin) is stored in the gate terminal of the second variable capacitance element N. In this case, in FIG. 9B, the sum Qtotal of the charge in the gate terminal of the first variable capacitance element P and the charge in the gate terminal of the second variable capacitance element N is (2·C1+ΔC)Vin+ΔC·(Vdd/2), and the amount of charge also depends on the bias voltage Vdd/2.

Therefore, in the output voltage signal Voutput in the boost state shown in FIG. 10C output from the amplifier, the bias voltage Vbias=Vdd/2 is also amplified, as represented by Formula 4 given below.

Voutput=(1+(kΔC)/(2C1+ΔC))(Vdd/2)+kVin=(1+(kΔC)/(2C1++ΔC))·Vbias+kVin [Formula 4]

In this case, as the capacitance difference ΔC is reduced, the amplification of the bias voltage Vbias represented by Formula 4 becomes smaller than that of the bias voltage amplified by the MOSFET parametric amplifier 50 according to the related art (the amplifier according to the related art shown in FIGS. 5A and 5B). However, when the bias voltage Vbias is amplified as represented by Formula 4, the same issue as that of the MOSFET parametric amplifier 50 according to the related art (the amplifier according to the related art shown in FIGS. 5A and 5B) is likely to occur.

Next, an amplifier according to a fourth structural example capable of solving the above-mentioned issues that is provided in the solid-state image sensing device 100 according to the embodiment of the present invention will be described.

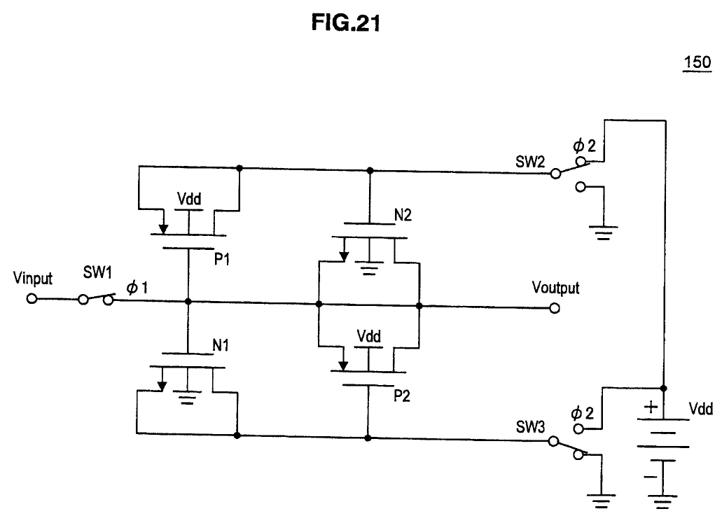

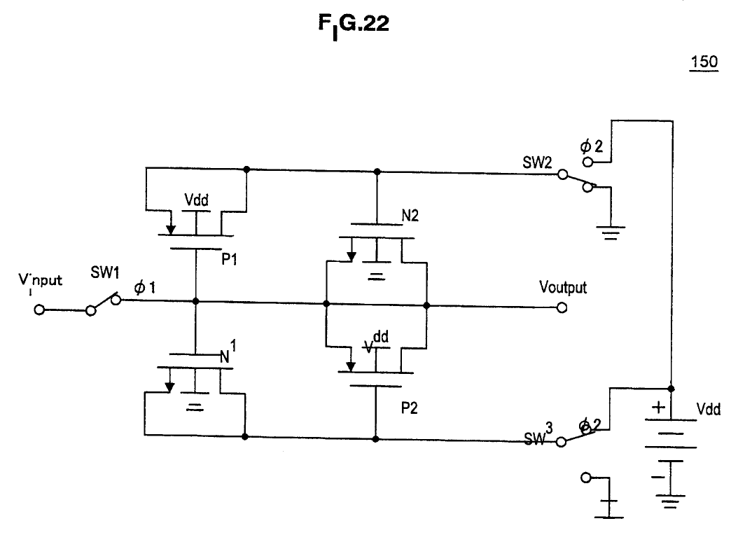

FIG. 21 is a first diagram illustrating an amplifier 150 according to the fourth structural example provided in the solid-state image sensing device 100 according to the embodiment of the present invention, and shows the track state of the amplifier 150. FIG. 22 is a second diagram illustrating the amplifier 150 according to the fourth structural example provided in the solid-state image sensing device 100 according to the embodiment of the present invention, and shows the boost state of the amplifier 150.

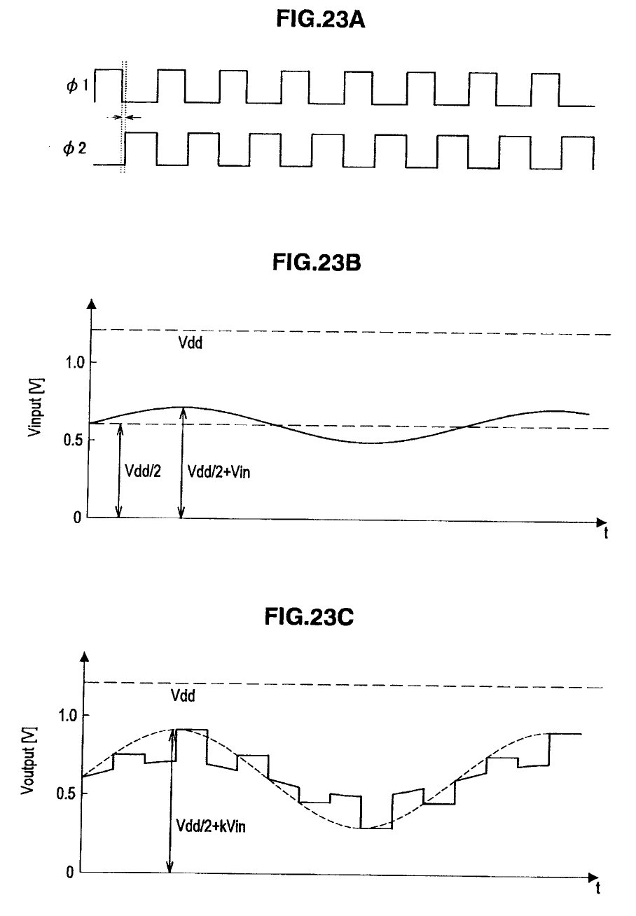

FIGS. 23A to 23C are third diagrams illustrating the amplifier 150 according to the fourth structural example provided in the solid-state image sensing device 100 according to the embodiment of the present invention. FIG. 23A shows control clock signals that control switches SW1, SW2, and SW3 of the amplifier 150 shown in FIGS. 21 and 22. FIG. 23B shows an example of the input voltage signal Vinput input to the amplifier 150, and FIG. 23C shows an example of the output voltage signal Voutput output from the amplifier 150. In FIGS. 21 to 23C, a bias voltage Vbias has a voltage level of Vdd/2 , but the bias voltage is not limited thereto.

Referring to FIGS. 21 and 22 the basic structure of the amplifier 150 according to the fourth structural example is similar to that of the amplifier 120 according to the first structural example except that it further includes a p-MOS varactor P2 and an n-MOS varactor N2. The capacitances of the p-MOS varactor P2 and the n-MOS varactor N2 vary depending on whether there is an inversion layer, similar to the MOSFET shown in FIGS. 4A and 4B. It is preferable that the width and length of the gate terminal of each of the p-MOS varactors P1 and P2 and the n-MOS varactors N1 and N2 included in the amplifier 150 be substantially equal to each other (that is, a production tolerance can be allowed).

Similar to the amplifier 120 according to the first structural example, the input voltage signal Vinput is input to the gate terminals of the p-MOS varactor PI and the n-MOS varactor N1 according to the connection state of the switch SW1. In addition similar to the amplifier 120 according to the first structural example, the source and drain terminals of the p-MOS varactor P1 are connected to the power supply voltage source or the ground according to the connection state of the switch SW2, and the source and drain terminals of the n-MOS varactor N1 are connected to the power supply voltage source or the ground according to the connection state of the switch SW3.

The input voltage signal Vinput is input to the source and drain terminals of the p-MOS varactor P2 and the source and drain terminals of the n-MOS varactor N2 according to the connection state of the switch SW1. In addition, the gate terminal of the n-MOS varactor N2 is connected to the power supply voltage source or the ground according to the connection state of the switch SW2, and the gate terminal of the p-MOS varactor P2 is connected to the power supply voltage source or the ground according to the connection state of the switch SW3.

In this case, since the p-MOS varactor P1 and the n-MOS varactor N1 have opposite conduction types and the p-MOS varactor P2 and the n-MOS varactor N2 have opposite conduction types, it is necessary to match the increase and decrease rates of the capacitances thereof. Therefore, in the amplifier 150, when the switch SW2 is connected to the power supply voltage source, the switch SW3 is connected to the ground, and when the switch SW2 is connected to the ground, the switch SW3 is connected to the power supply voltage source.

Therefore, control signals having different voltage levels (a control signal having a first level and a control signal having a second level) are input to the source and drain terminals of the p-MOS varactor P1 and the source and drain terminals of the n-MOS varactor N1. In addition, the control signals having different voltage levels (the control signal having the first level and the control signal having the second level) are input to the gate terminal of the n-MOS varactor N2 and the gate terminal of the P-MOS varactor P2.

In the track state of the amplifier 150 shown in FIG. 21, for example, when a clock signal φ1 is at a high level, the switch SW1 is turned on, and the input voltage signal Vinput is input to the gate terminal of the p-MOS varactor P1, the gate terminal of the n-MOS varactor N1, the source and drain terminals of the n-MOS varactor N2, and the source and drain terminals of the p-MOS varactor P2.

In addition, for example, when the clock signal φ2 is at a low level, the switch SW2 is connected to the power supply voltage source. For example, when the clock signal φ2 is at the low level, the switch SW3 is connected to the ground. In this case, an inversion layer is generated in each of the p-MOS varactor P1 and the n-MOS varactor N1, and the capacitances of the varactors increase. Therefore, the voltages of the gate terminals of the p-MOS varactor P1 and the n-MOS varactor N l vary depending on the input voltage signal Vinput, similar to the amplifier 120 according to the first structural example, and a charge corresponding to the input voltage signal Vinput is stored in each of the p-MOS varactor P1 and the n-MOS varactor N1.

Similarly, when the switch SW2 is connected to the power supply voltage source and the switch SW3 is connected to the ground, an inversion layer is generated in each of the p-MOS varactor P2 and the n-MOS varactor N2, and the capacitances of the varactors increase.

Therefore, in the track state of the amplifier 150 shown in FIG. 21, the inversion layer is generated on a semiconductor interface immediately below the gate terminal of each of the p-MOS varactors P1 and P2, and the n-MOS varactors N1 and N2 and the capacitances thereof increase.

Next, the capacitances of the p-MOS varactors P1 and P2 and the n-MOS varactors N1 and N2 in the track state of the amplifier 150 will be described.

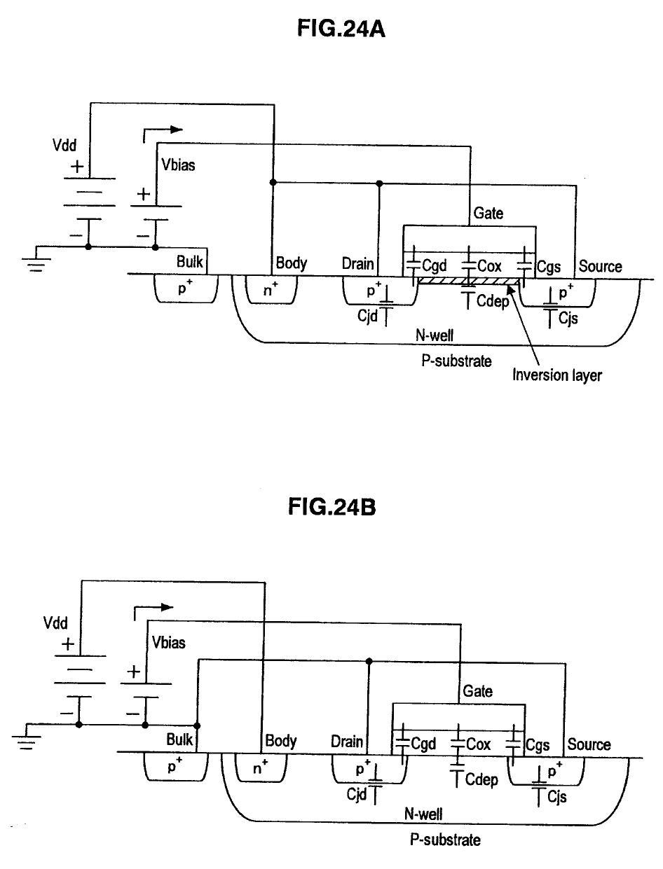

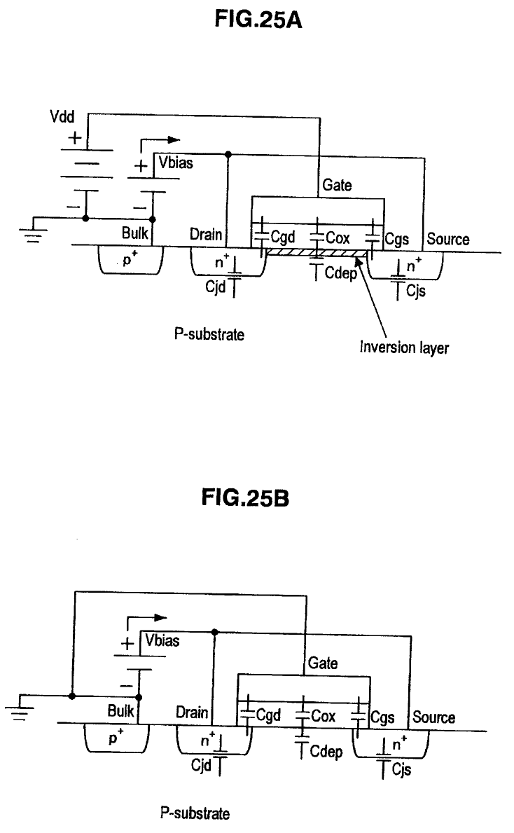

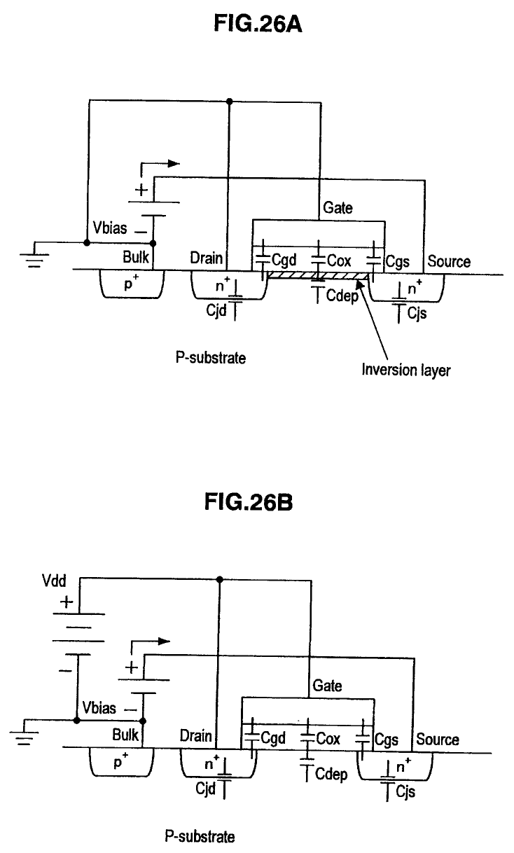

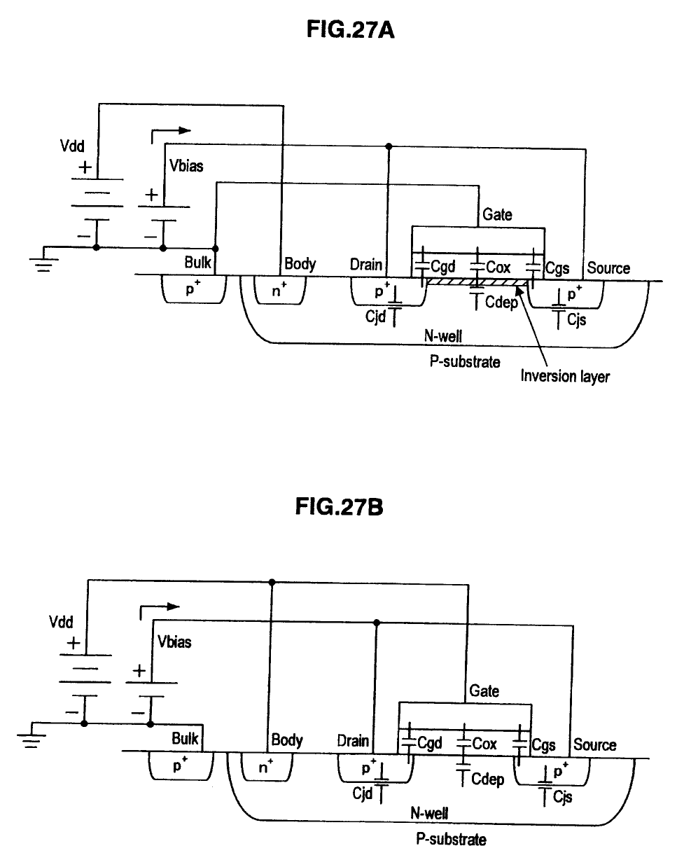

FIGS. 24A and 24B are diagrams schematically illustrating the p-MOS varactor P1 of the amplifier 150 according to the fourth structural example included in the solid-state image sensing device 100 according to the embodiment of the present invention. FIG. 24A shows the track state of the p-MOS varactor P1, and FIG. 24B shows the boost state of the p-MOS varactor P1. FIGS. 25A and 25B are diagrams schematically illustrating the n-MOS varactor N2 of the amplifier 150 according to the fourth structural example included in the solid-state image sensing device 100 according to the embodiment of the present invention. FIG. 25A shows the track state of the n-MOS varactor N2, and FIG. 25B shows the boost state of the n-MOS varactor N2. FIGS. 26A and 26B are diagrams schematically illustrating the n-MOS varactor N1 of the amplifier 150 according to the fourth structural example included in the solid-state image sensing device 100 according to the embodiment of the present invention. FIG. 26A shows the track state of the n-MOS varactor N1, and FIG. 26B shows the boost state of the n-MOS varactor N1. FIGS. 27A and 27B are diagrams schematically illustrating the p-MOS varactor P2 of the amplifier 150 according to the fourth structural example included in the solid-state image sensing device 100 according to the embodiment of the present invention. FIG. 27A shows the track state of the p-MOS varactor P2, and FIG. 27B shows the boost state of the p-MOS varactor P2.

In FIGS. 24A to 27B, Cgd indicates the fringe capacitance and the overlap capacitance between the gate terminal and the drain terminal. In addition, Cox indicates the capacitance of a gate oxide film, and Cgs indicates the fringe capacitance and the overlap capacitance between the gate terminal and the source terminal. Further, Cdep indicates the capacitance of a depletion layer immediately below the gate terminal. Cjd indicates the junction capacitance of the drain terminal, and Cjs indicates the junction capacitance of the source terminal.

<Capacitance of p-MOS Varactor P1 in Track State (FIG. 24A)>

Referring to FIG. 24A, a capacitance C_{max,P1} as viewed from the gate terminal in the track state is represented by Formula 5 given below since an electric field is terminated by the inversion layer.

C_{max,P1}=Cox+Cgd+Cgs [Formula 5]

<Capacitance of n-MOS Varactor N2 in Track State (FIG. 25A)>

Referring to FIG. 25A, a capacitance C_{max,N2} as viewed from the drain and source terminals in the track state is represented by Formula 6 given below since capacitances for the gate terminal are Cgd, Cox, and Cgs and capacitances for the bulk terminal are Cjd, Cdep, and Cjs.

C_{max,N2}=Cox+Cgd+Cgs+Cjd+Cjs+Cdep [Formula 6]

<Capacitance of n-MOS Varactor N1 in Track State (FIG. 26A)>

Referring to FIG. 26A, a capacitance C_{max,N1} as viewed from the gate terminal in the track state is represented by Formula 7 given below since an electric field is terminated by the inversion layer.

C_{max,N1}=Cox+Cgd+Cgs [Formula 7]

<Capacitance of p-MOS Varactor P2 in Track State (FIG. 27A)>

Referring to FIG. 27A, a capacitance C_{max,P2} as viewed from the drain and source terminals in the track state is represented by Formula 8 given below since capacitances for the gate terminal are Cgd, Cox, and Cgs and capacitances for a body (N-well contact) are Cjd, Cdep, and Cjs.

C_{max,P2}=Cox+Cgd+Cgs+Cjd+Cjs+Cdep [Formula 8]

### <Capacitance of Amplifier 150 in Track State>

Therefore, for example, the capacitances C_{a,max} and C_{b,max} of the amplifier 150 in the track state are respectively represented by Formula 9 and Formula 10 given below.

$$\begin{matrix}\begin{matrix}{C}_{a , max} = {C}_{max , P 1} + {C}_{max , N 2} \\ = Cox , p + Cgd , p + Cgs , p + Cox , n + \\ Cgd , n + Cgs , n + Cjd , n + \\ Cjs , n + Cdep , n\end{matrix} & [ Formula 9 ] \\ \begin{matrix}{C}_{b , max} = {C}_{max , N 2} + {C}_{max , P 2} \\ = Cox , n + Cgd , n + Cgs , n + \\ Cox , p + Cgd , p + \\ Cgs , p + Cjd , p + Cjs , p + Cdep , p \\ = Cox , p + Cgd , p + Cgs , p + \\ Cox , n + Cgd , n + \\ Cgs , n + Cjd , p + Cjs , p + Cdep , p\end{matrix} & [ Formula 10 ]\end{matrix}$$

The capacitance C_{a,max} represented by Formula 9 is the capacitance of an upper part in FIGS. 21 and 22 (the sum of the capacitance of the p-MOS varactor P1 and the capacitance of the n-MOS varactor N2, that is, the sum of Formula 5 and Formula 6). In addition, the capacitance C_{b,max} represented by Formula 10 is the capacitance of a lower part in FIGS. 21 and 22 (the sum of the capacitance of the n-MOS varactor N1 and the capacitance of the p-MOS varactor P2, that is, the sum of Formula 7 and Formula 8). In Formulae 9 and 10, for example, Cox,p indicates the capacitance Cox of the p-MOS varactor, and Cox,n indicates the capacitance Cox of the n-MOS varactor. This is similarly applied to the other terms.

As can be seen from comparison between Formula 9 and Formula 10, the capacitances Cjd, Cjs, and Cdep of the p-MOS varactor are different from those of the n-MOS varactor, but the other terms are equal to each other. Therefore, the value represented by Formula 9 and the value represented by Formula 10 depend on the values of Cjd, Cjs, and Cdep, and there is a difference between the values. Cjd and Cjs are called junction capacitance. When the sizes of the MOS varactors are substantially equal to each other (the size refers to the width and length of the gate terminal), the p-MOS varactor and the n-MOS varactor have substantially the same capacitance. In contrast, since Cdep indicates the capacitance of a depletion layer immediately below the gate terminal, the p-MOS varactor and the n-MOS varactor have different capacitances. However, since the capacitance of the depletion layer is significantly smaller than the sum of the other capacitances, it can be neglected as an allowable error.

Therefore, when the MOS varactors of the amplifier have substantially the same size, there is no capacitance difference ΔC in the amplifier 150 in the track state (strictly, the capacitance difference ΔC is so small as to be negligible).

Then, referring to FIG. 22, in the boost state of the amplifier 150, for example, when the clock signal φ1 is at a low level, the switch SW1 is turned off, and the input of the input voltage signal Vinput to the gate terminals of the p-MOS varactor P1 and the n-MOS varactor N1 and the source and drain terminals of the p-MOS varactor P2 and the n-MOS varactor N2 stops.

In addition, for example, when the clock signal φ2 is at a high level, the switch SW2 is connected to the ground. For example, when the clock signal φ2 is at the high level, the switch SW3 is connected to the power supply voltage source. In this case, the inversion layer generated on the semiconductor interface immediately below the gate terminal of each of the p-MOS varactors P1 and P2 and the n-MOS varactors N1 and N2 is removed, the capacitances of the p-MOS varactors P1 and P2 and the n-MOS varactors N1 and N2 are reduced.

Next, the capacitances of the p-MOS varactors P1 and P2 and the n-MOS varactors N1 and N2 in the boost state of the amplifier 150 will be described.

<Capacitance of p-MOS Varactor P1 in Boost State (FIG. 24B)>

Referring to FIG. 24B, a capacitance C_{min,P1} as viewed from the gate terminal in the boost state is represented by Formula 11 given below since the inversion layer is removed and the capacitances Cox and Cdep are formed.

C_{min,P1}=(Cox·Cdep)/(Cox+Cdep)+Cgd+Cgs [Formula 11]

<Capacitance of n-MOS Varactor N2 in Boost State (FIG. 25B)>

Referring to FIG. 25B, a capacitance C_{min,N2} as viewed from the drain and source terminals in the boost state is represented by Formula 12 given below since the inversion layer is removed and the capacitances Cox and Cdep are not formed.

C_{min,N2}=Cgd+Cgs+Cjd+Cjs [Formula 12]

<Capacitance of n-MOS Varactor N1 in Boost State (FIG. 26B)>

Referring to FIG. 26B, a capacitance C_{min,N1} as viewed from the gate terminal in the boost state is represented by Formula 13 given below since the inversion layer is removed and the capacitances Cox and Cdep are formed.

C_{min,N1}=(Cox−Cdep)/(Cox+Cdep)+Cgd+Cgs [Formula 13]

<Capacitance of p-MOS Varactor P2 in Boost State (FIG. 27B)>

Referring to FIG. 27B, a capacitance C_{min,P2} as viewed from the drain and source terminals in the boost state is represented by Formula 14 given below since the inversion layer is removed and the capacitances Cox and Cdep are not formed.

C_{min,P2}=Cgd+Cgs+Cjd+Cjs [Formula 14]

### <Capacitance of Amplifier 150 in Boost State>

Therefore, for example, the capacitances C_{a,min} and C_{b,min} of the amplifier 150 in the boost state are respectively represented by Formula 15 and Formula 16 given below.

$$\begin{matrix}\begin{matrix}{C}_{a , min} = {C}_{min , P 1} + {C}_{min , N 2} \\ = ( Cox , p \cdot Cdep , p ) / ( Cox , p + Cdep , p ) + \\ Cgd , p + Cgs , p + Cgd , n + Cgs , n + \\ Cjd , n + Cjs , n\end{matrix} & [ Formula 15 ] \\ \begin{matrix}{C}_{b , min} = {C}_{min , N 1} + {C}_{min , P 2} \\ = ( Cox , n \cdot Cdep , n ) / ( Cox , n + Cdep , n ) + \\ Cgd , n + Cgs , n + Cgd , p + Cgs , p + \\ Cjd , p + Cjs , p \\ = ( Cox , n \cdot Cdep , n ) / ( Cox , n + Cdep , n ) + \\ Cgd , p + Cgs , p + Cgd , n + Cgs , n + \\ Cjd , p + Cjs , p\end{matrix} & [ Formula 16 ]\end{matrix}$$

The capacitance C_{a,min} represented by Formula 15 is the capacitance of the upper part in FIGS. 21 and 22 (the sum of the capacitance of the p-MOS varactor P1 and the capacitance of the n-MOS varactor N2, that is, the sum of Formula 11 and Formula 12). In addition, the capacitance C_{b,min} represented by Formula 16 is the capacitance of the lower part in FIGS. 21 and 22 (the sum of the capacitance of the n-MOS varactor N1 and the capacitance of the p-MOS varactor P2, that is, the sum of Formula 13 and Formula 14).

As can be seen from comparison between Formula 15 and Formula 16, the capacitances Cjd and Cjs and the fringe capacitance (the first term in Formulae 15 and 16) between Cox and Cdep of the p-MOS varactor are different from those of the n-MOS varactor, but the other terms are equal to each other. Therefore, the value represented by Formula 15 and the value represented by Formula 16 depend on the values of Cjd, Cjs, Cox, and Cdep, and there is a difference between the values. As described above, when the sizes of the MOS varactors are substantially equal to each other, the capacitances Cjd and Cjs of the p-MOS varactor and the n-MOS varactor do not vary. However, since the fringe capacitance between Cox and Cdep is sufficiently smaller than Cdep in both the p-MOS varactor and the n-MOS varactor, the difference between the fringe capacitances between Cox and Cdep in Formulae 15 and 16 is also sufficiently small. Therefore, the difference between the fringe capacitances between Cox and Cdep in Formulae 15 and 16 can be neglected as an allowable error.

Therefore, when the MOS varactors of the amplifier have substantially the same size, there is no capacitance difference ΔC in the amplifier 150 in the boost state (strictly, the capacitance difference ΔC is so small as to be negligible).

In addition, the capacitance of the amplifier 150 in the track state, that is, the maximum capacitance Cmax of the amplifier 150 may be the sum of Formula 9 and Formula 10. Therefore, for example, the maximum capacitance of the amplifier 150 can be represented by Formula 17 given below.

$$\begin{matrix}C max = {C}_{a , max} + {C}_{b , max} \\ = 2 ( Cox , p + Cox , n ) + Cdep , p + \\ Cdep , n + 2 ( Cgd , p + Cgs , p + \\ Cgd , n + Cgs , n ) + Cjd , p + Cjs , p + \\ Cjd , n + Cjs , n\end{matrix} \qquad [ Formula 17 ]$$

In addition, the capacitance of the amplifier 150 in the boost state, that is, the minimum capacitance Cmin of the amplifier 150 may be the sum of Formula 15 and Formula 16 . Therefore, for example, the minimum capacitance of the amplifier 150 can be represented by Formula 18 given below.

$$\begin{matrix}C min = {C}_{a , min} + {C}_{b , min} \\ = [ ( Cox , p \cdot Cdep , p ) / ( Cox , p + Cdep , p ) + \\ ( Cox , n \cdot Cdep , n ) / ( Cox , n + Cdep , n ) ] + \\ 2 ( Cgd , p + Cgs , p + Cgd , n + Cgs , n ) + \\ Cjd , p + Cjs , p + Cjd , n + Cjs , n\end{matrix} \qquad [ Formula 18 ]$$

As can be seen from Formulae 17 and 18, Cox and Cdep contribute to the capacitance change ratio. When the p-MOS varactor and the n-MOS varactor are in the boost state, Cox varies depending on the series capacitance of Cox and Cdep. Therefore, it is preferable that the amplifier 150 be laid out such that capacitances other than Cox are as possible as small, in order to increase the capacitance change ratio. Specifically, it is possible to reduce the areas of the drain terminal and the source terminal with respect to the area of a gate region by increasing the length of the gate of each of the MOS varactors provided in the amplifier 150. Therefore, the above-mentioned layout of the amplifier 150 makes it possible to increase the capacitance change ratio.

As described above, in the track state and the boost state of the amplifier 150, there is no capacitance difference ΔC. In the boost state, the amplifier 150 can amplify the voltage signal Vin by the capacitance change ratio while maintaining the level of the bias voltage Vbias, using the variation in capacitance represented by Formulae 2 and 3, similar to the amplifier 120 according to the first structural example.

Therefore, as shown in FIG. 23C, the output voltage Voutput of the amplifier 150 has a waveform in which the level of the bias voltage Vdd/2 is maintained and the pixel signal Vin is amplified by the capacitance change ratio, for the input voltage signal Vinput. Since the level of the output voltage signal Voutput is lower than that of the power supply voltage Vdd (the control signal having the second level), no distortion occurs in an output voltage, unlike the MOSFET parametric amplifier 50 according to the related art.

In the amplifier 150 according to the fourth structural example, the p-MOS varactor and the n-MOS varactor having substantially the same size are vertically arranged (for example, the term ‘vertical arrangement’ refers to relative arrangement shown in FIG. 21. Therefore, ‘horizontal arrangement’ or ‘inclination’ is also included in the structure of the amplifier 150 according to the fourth structural example). In this case, if the MOS varactors have substantially the same size and have the same conduction type, the capacitance difference between the MOS varactors is very small even when there is a process variation in the n-MOS varactors of the amplifier 150. Therefore, in the amplifier 150, even when there is a process variation in the p-MOS varactor and the n-MOS varactor of the amplifier 150, it is possible to significantly reduce the capacitance difference ΔC. As a result, the amplifier 150 can maintain the level of the bias voltage Vbias included in the input voltage signal Vinput after amplification.

Therefore, the amplifier 150 according to the fourth structural example of the embodiment of the present invention can output the output voltage signal Voutput having a waveform in which the level of the bias voltage Vbias is maintained and the pixel signal Vin is amplified by the capacitance change ratio, for the input voltage signal Vinput. Therefore, the level of the output voltage signal Voutput is not excessively high. As a result, in a circuit including the amplifier 150, it is not necessary to take a special measure for the output voltage signal Voutput of the amplifier 150, and it is possible to reduce the power consumption and the size of the circuit. In addition, the amplifier 150 can significantly reduce the probability that the level of the output voltage signal Voutput is higher than that of the power supply voltage Vdd (the control signal having the second level). Therefore, no distortion occurs in the output voltage signal Voutput, and it is possible to obtain a desired output voltage signal Voutput without noise.

### [5] Fifth Structural Example of Amplifier

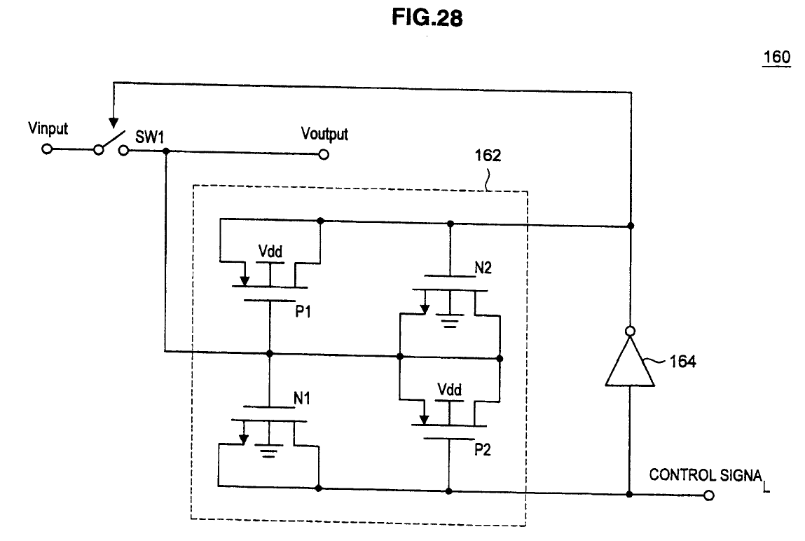

In the above-mentioned structure, in the amplifiers according to the first to fourth structural examples, the switch SW2 and the switch SW3 are selectively turned on or off to connect the variable capacitance elements to the ground or the power supply voltage source, and the control signal having the first level or the control signal having the second level is supplied to the variable capacitance element. However, the amplifier according to the embodiment of the present invention is not limited to the above-mentioned structure. FIG. 28 is a diagram illustrating an amplifier 160 according to a fifth structural example provided in the solid-state image sensing device 100 according to the embodiment of the present invention.

Referring to FIG. 28, the amplifier 160 includes an amplifying circuit 162, an inverter 164, and a switch SW1. In addition, an input voltage signal Vinput and control signals are input to the amplifier 160. In this structure, the input voltage signal Vinput is transmitted through the signal lines, similar to the amplifiers according to the first to fourth structural examples. The control signals are supplied from a control signal generating unit (not shown) that selectively outputs a control signal having a first level or a control signal having a second level. The control signal generating unit (not shown) is provided in the solid-state image sensing device according to the embodiment of the present invention, but the present invention is not limited thereto. For example, the control signal generating unit may be provided in an external apparatus, such as an imaging apparatus including the solid-state image sensing device according to the embodiment of the present invention.

The amplifying circuit 162 includes p-MOS varactors P1 and P2 and n-MOS varactors N1 and N2, and has the same structure as the amplifier 150 according to the fourth structural example shown in FIG. 21. Therefore, the amplifying circuit 162 can amplify the input voltage signal Vinput, similar to the amplifier 150 according to the fourth structural example. Alternatively, the amplifying circuit 162 may have the same structure as the amplifiers according to the first to third structural examples.

The inverter 164 inverts the level of an input control signal, and outputs the inverted control signal to the source and drain terminals of the p-MOS varactor P1 and the gate terminal of the n-MOS varactor N2. Therefore, control signals having different voltage levels (the control signal having the first level and the control signal having the second level) are input to the source and drain terminals of the p-MOS varactor P1 and the source and drain terminals of the n-MOS varactor N1. In addition, control signals having different voltage levels (the control signal having the first level and the control signal having the second level) are input to the gate terminal of the n-MOS varactor N2 and the gate terminal of the p-MOS varactor P2.

Further, the inverter 164 outputs the inverted control signal to the switch SW1. Therefore, in the amplifier 160 shown in FIG. 28, the inverted control signal serves as the clock signal φ1 shown in, for example, FIG. 15A.

The amplifier 160 differs from the amplifier according to the fourth structural example in that it supplies the control signals having different voltage levels to the variable capacitance elements using the inverter 164 without using the switches SW2 and SW3, but the principle of amplification by the amplifier 160 is the same as that by the amplifier according to the fourth structural example. Therefore, the amplifier 160 according to the fifth structural example of the embodiment of the present invention can output an output voltage signal Voutput having a waveform in which the level of the bias voltage Vbias is maintained and the pixel signal Vin is amplified by the capacitance change ratio, for the input voltage signal Vinput. Therefore, the level of the output voltage signal Voutput is not excessively high. As a result, in a circuit including the amplifier 160, it is not necessary to take a special measure for the output voltage signal Voutput of the amplifier 160, and it is possible to reduce the power consumption and the size of the circuit. In addition, the amplifier 160 can significantly reduce the probability that the level of the output voltage signal Voutput is higher than that of the power supply voltage Vdd (the control signal having the second level). Therefore, no distortion occurs in the output voltage signal Voutput, and it is possible to obtain a desired output voltage signal Voutput without noise.

The amplifying unit 106 including the amplifiers according to the first to fifth structural examples can amplify the pixel signal transmitted through each signal line.

The amplifier according to the embodiment of the present invention includes the p-MOS varactors and/or the n-MOS varactors. In addition, in the boost state, the amplifier according to the embodiment of the present invention changes capacitance according to the voltage level of the control signal having the second level (Specifically, the amplifier changes the capacitance to be reduced) to amplify the input voltage signal Vinput by the capacitance change ratio. Therefore, the solid-state image sensing device 100 can control the voltage level of the control signal having the second level applied to each of the amplifiers of the amplifying unit 106 to adjust the amplification factor of a pixel signal. In this case, for example, a control signal generating unit (not shown) of the solid-state image sensing device 100 can control the control signal having the second level, but the present invention is not limited thereto. For example, the row driving circuit 104 may control the control signal having the second level, or the control signal generating unit (not shown) may be provided in an external apparatus, such as an imaging apparatus including the solid-state image sensing device 100.

### [Example of Operation of Amplifier According to the Embodiment of the Invention]

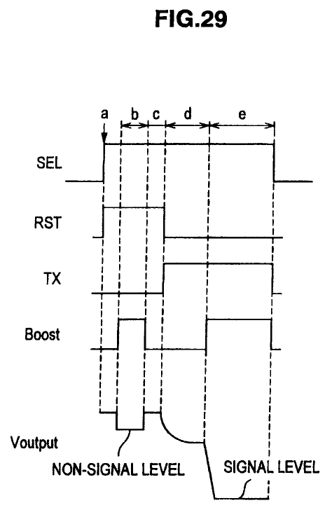

Next, an example of the operation of the amplifier provided in the solid-state image sensing device 100 according to the embodiment of the present invention will be described. FIG. 29 is a diagram illustrating an example of the operation of the amplifier provided in the solid-state image sensing device 100 according to the embodiment of the present invention. In FIG. 29, the amplifier 160 according to the fifth structural example shown in FIG. 28 is given as an example. In addition, FIG. 29 shows the signal SEL (selection signal), the signal RST, and the signal TX supplied to the pixel 102a1 shown in FIG. 12, a control signal Boost supplied to the amplifier 160, and the output voltage signal Voutput that is output from the amplifier 160.

When the selection signal SEL is changed from a low level to a high level (time a in FIG. 29), the signal RST is also changed from a low level to a high level, and a reset voltage is applied to the gate terminal of the transistor M3 shown in FIG. 12 by the signal RST to reset the transistor. During the period for which the signal RST is at the high level, when the control signal Boost is changed from a low level (first level) to a high level (second level), the amplifier outputs the output voltage signal Voutput without a pixel signal (an output voltage signal having non-signal level) (period b in FIG. 29).

When the control signal Boost is changed from the high level (second level) to the low level (first level), the transistor M3 shown in FIG. 12 is reset again (period c in FIG. 29). Then, when the signal TX is changed from a low level to a high level, the transmission of the pixel signal generated by the photodiode PD1 starts, and the output voltage signal Voutput varies depending on the amount of pixel signal (period d in FIG. 29). In this case, when the control signal Boost is changed from the low level to the high level, the amplifier outputs the output voltage signal Voutput (an output voltage signal having a signal level) that is obtained by amplifying the pixel signal by the capacitance change ratio of the variable capacitance elements of the amplifying circuit 162 (period e in FIG. 29).

For example, the control signal Boost shown in FIG. 29 is supplied to the amplifier included in the solid-state image sensing device 100 according to the embodiment of the present invention to amplify an input pixel signal by the capacitance change ratio of the variable capacitance elements.

In FIG. 29, during both the period for which the signal RST is at the high level (period b in FIG. 29) and the period for which the signal TX is at the high level (period e in FIG. 29), the control signal Boost is at the high level (second level). In this case, for example, it is possible to improve the characteristics of a CMOS image sensor by detecting a voltage difference between an output voltage signal having non-signal level and an output voltage signal having a signal level. The operation of the amplifier included in the solid-state image sensing device 100 according to the embodiment of the present invention is not limited to the above. For example, when it is not necessary to detect the voltage difference between the output voltage signal having non-signal level and the output voltage signal having a signal level, the control signal Boost may be at the high level (second level) only during the period for which the signal TX is at the high level (period e in FIG. 29). In this case, as described above, the amplifier according to the embodiment of the present invention can also amplify an input pixel signal by the capacitance change ratio of the variable capacitance elements.

Next, components of the solid-state image sensing device 100 according to the embodiment of the present invention will be described with reference to FIG. 8 again. A multiplexer 108 multiplexes the pixel signals amplified by the amplifiers and outputs an image signal (the multiplexed pixel signal) to an A/D converter 110.

The A/D converter 110 converts the image signal output from the multiplexer 108 into a digital signal. The converted digital image signal is transmitted to, for example, a signal processing circuit (not shown) of an imaging apparatus (not shown), and a signal processing circuit (not shown) performs various processes, such as a JPEG coding process.

The solid-state image sensing device 100 can obtain image signals corresponding to the captured image of a subject using, for example, the structure shown in FIG. 8.

As described above, the solid-state image sensing device 100 according to the embodiment of the present invention includes the pixel unit 102 having pixels, each selectively transmitting the pixel signal generated by a photoelectric conversion element to the corresponding signal line, and the amplifying unit 106 having amplifiers that are connected to the signal lines and amplify the pixel signals transmitted through the signal lines, and amplifies the pixel signal transmitted from each of the pixels. Then, the solid-state image sensing device 100 multiplexes the amplified pixel signals to obtain an image signal corresponding to the captured image of a subject.

In this structure, the amplifiers provided in the amplifying unit 106 are composed of variable capacitance elements. Therefore, the amplifier according to the embodiment of the present invention does not have the above-mentioned three issues (difficulty in reducing the size of the amplifier, the generation of noise, and large power consumption) of the amplifier according to the related art shown in FIG. 2 that includes an operational amplifier and a switched capacitor circuit. Therefore, the solid-state image sensing device 100 can prevent the above-mentioned three issues of the solid-state image sensing device 10 according to the related art that includes the amplifiers (the amplifiers shown in FIG. 2) using operational amplifiers, that is, difficulty in reducing the size of the solid-state image sensing device 10, a reduction in sensitivity, and an increase in the overall power consumption of the solid-state image sensing device.

Each of the amplifiers included in the amplifying unit 106 amplifies the input voltage signal Vinput and amplifies the pixel signal by the capacitance change ratio while holding the level of the bias voltage, using the principle of amplification described with reference to FIGS. 9A to 11C. Therefore, in the amplifier according to the embodiment of the present invention, the above-mentioned two issues of the MOSFET parametric amplifier 50 according to the related art (the amplifier shown in FIGS. 5A and 5B) (difficulty in reducing the power consumption or the size of a circuit, and the generation of noise) are less likely to occur. As a result, the solid-state image sensing device 100 can prevent the above-mentioned two issues of the solid-state image sensing device 10 according to the related art that includes the MOSFET parametric amplifier 50 according to the related art (the amplifier shown in FIGS. 5A and 5B), that is, difficulty in reducing the power consumption or the size of the solid-state image sensing device 10 and a reduction in sensitivity.

Therefore, the solid-state image sensing device 100 can prevent a reduction in sensitivity and reduce power consumption.

### (Amplification Method Performed in Amplifier of Solid-state Image Sensing Device According to the Embodiment of the Invention)

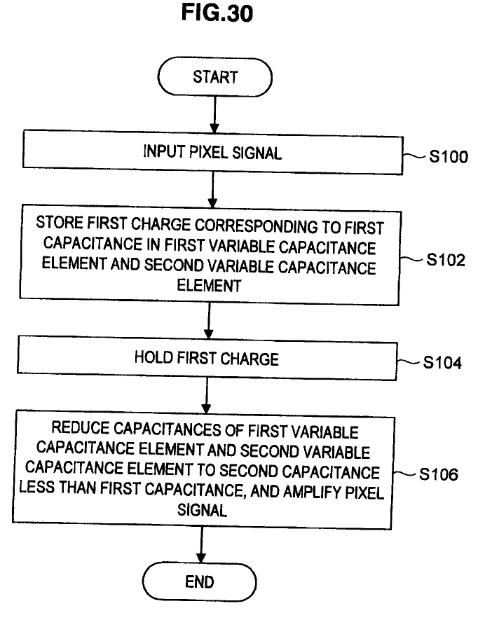

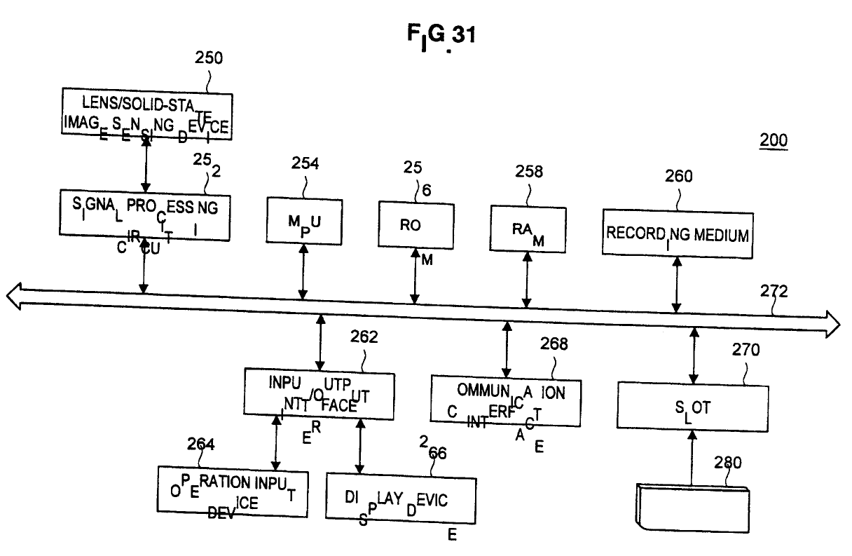

Next, an amplification method performed in the amplifier of the solid-state image sensing device 100 according to the embodiment of the present invention will be described. FIG. 30 is a flowchart illustrating an example of the amplification method performed in the amplifier of the solid-state image sensing device 100 according to the embodiment of the present invention. In the following description, the structure in which the solid-state image sensing device 100 includes amplifiers each having a first variable capacitance element and a second variable capacitance element (the amplifiers according to the first to fourth structural examples) is given as an example.

The solid-state image sensing device 100 inputs a pixel signal to the amplifier (S100). In Step S100, when the pixel signal is input, the solid-state image sensing device 100 stores a first charge corresponding to a first capacitance (first value) in the first variable capacitance element and the second variable capacitance element of the amplifier (S102). In this case, for example, the solid-state image sensing device 100 controls the switch SW1 of the amplifier to perform Steps S 100 and S102.

The solid-state image sensing device 100 holds the first charge stored in Step S102 (S104). In this case, for example, the solid-state image sensing device 100 controls the switch SW1 of the amplifier to perform Step S104.

The solid-state image sensing device 100 reduces the capacitances of the first variable capacitance element and the second variable capacitance element of the amplifier to a second capacitance (second value) that is smaller than the first capacitance (first value), and amplifies the pixel signal by the capacitance change ratio (S106). In this case, for example, the solid-state image sensing device 100 supplies control signals having different voltage levels (a control signal having a first level and a control signal having a second level) to the first variable capacitance element and the second variable capacitance element of the amplifier to perform Step S106.

The solid-state image sensing device 100 can prevent a reduction in sensitivity and reduce power consumption using the method shown in FIG. 30.

### (Imaging Apparatus According to the Embodiment of the Invention)

The solid-state image sensing device 100 according to the embodiment of the present invention can be applied to, for example, an imaging apparatus. Next, an imaging apparatus including the solid-state image sensing device 100 according to the embodiment of the present invention will be described. FIG. 31 is a diagram illustrating an example of the hardware structure of an imaging apparatus 200 according to the embodiment of the present invention.

Referring to FIG. 31, the imaging apparatus 200 may include a lens/solid-state image sensing device 250, a signal processing circuit 252 (signal processing unit), an MPU 254, a ROM 256, a RAM 258, a recording medium 260, an input/output interface 262, an operation input device 264, a display device 266, a communication interface 268, and a slot 270. In addition, in the imaging apparatus 200, for example, the components may be connected to each other by a bus 272 serving as a data transmission path.

The lens/solid-state image sensing device 250 includes, for example, lenses of an optical system and the solid-state image sensing device 100 according to the embodiment of the present invention shown in FIG. 8, and outputs image signals corresponding to the captured image of a subject. The solid-state image sensing device 100 shown in FIG. 8 includes the A/D converter 110, and outputs a digital image signal (hereinafter, referred to as ‘image data’), but the present invention is not limited thereto. For example, the lens/solid-state image sensing device 250 may output an analog image signal.

The signal processing circuit 252 performs various processes on the image data transmitted from the lens/solid-state image sensing device 250. When an analog image signal is transmitted from the lens/solid-state image sensing device 250 (that is, when the solid-state image sensing device does not include the A/D converter), the signal processing circuit 252 may include, for example, an AGC (automatic gain control) circuit or an A/D converter, convert the image signal into a digital signal (image data), and perform various signal processing operations on the digital signal.

Example of the signal processing performed by the signal processing circuit 252 include a white balance correcting process, an interpolation process, a color correcting process, a gamma correcting process, a YCbCr conversion process, an edge enhancement process, and a JPEG coding process, but the present invention is not limited thereto. In the white balance correcting process, for example, a gain is set to each of R, G, and B (red, green, and blue) of raw image data (image data before signal processing) and a pixel value corresponding to each pixel (pixel) is amplified by the gain. The interpolation process makes R, G, and B data of all the pixels from, for example, a Bayer array. The correcting process corrects, for example, the color of an image. For example, the gamma correcting process non-linearly converts RGB signals and ensures visual linearity. The YCbCr conversion process converts RGB into YCbCr on the basis of, for example, a predetermined transform. In this case, Y indicates luminance, Cb indicates chrominance, and Cr indicates chrominance. For example, the edge enhancement process detects an edge from an image, and increases the luminance of the detected edge to enhance the depth of an image. The JPEG coding process converts image data into an image file having a JPEG format. It goes without saying that the process of the signal processing circuit 252 of the imaging apparatus 200 according to the embodiment of the present invention is not limited to the above.

The signal processing circuit 252 may compress the processed image data and record the compressed data on various types of recording media (for example, a recording medium 260 and an external memory 280). In addition, the signal processing circuit 252 may expand the image data read from various types of recording media and display the image data on the display device 266.

The MPU 254 serves as a control unit that controls the overall operation of the imaging apparatus 200. The ROM 256 stores programs used by the MPU 254 or control data, such as operation parameters, and the RAM 258 temporarily stores the programs executed by the MPU 254.

The recording medium 260 serves as a storage unit of the imaging apparatus 200, and stores, for example, image data (image file) recorded by the signal processing circuit 252 or various applications. Examples of the recording medium 260 include a magnetic recording medium, such as a hard disk, and nonvolatile memories, such as an EEPROM (electronically erasable and programmable read only memory), a flash memory, an MRAM (magnetoresistive random access memory), an FeRAM (ferroelectuic random access memory), and a PRAM (phase change random access memory), but the present invention is not limited thereto.

The input/output interface 262 connects, for example, the operation input device 264 and the display device 266. Examples of the input/output interface 262 include a USB (universal serial bus) interface, a DVI (digital visual interface), and an HDMI (high-definition multimedia interface), but the present invention is not limited thereto. Examples of the operation input device 264 include buttons, arrow keys, a rotary selector, such as a jog dial, and combinations thereof. The operation input device 264 is provided at an upper side of the imaging apparatus 200 and is connected to the input/output interface 262 inside the imaging apparatus 200. Examples of the display device 266 include an LCD) (liquid crystal display) and an organic electroluminescent display (which is also called an organic light emitting diode display). The display device 266 is provided at an upper side of the imaging apparatus 200, and is connected to the input/output interface 262 inside the imaging apparatus 200. The input/output interface 262 may be connected to an operation input device (for example, a keyboard or a mouse) or a display device (for example, an external display), which is an external device of the imaging apparatus 200.

The communication interface 268 is for communication with an external apparatus, and serves as a communication unit. Examples of the communication interface 268 include a LAN terminal, an IEEE802.11 port, and an RF (radio frequency) circuit, but the present invention is not limited thereto.

The slot 270 has an insertion hole through which an external memory can be inserted or removed, and serves as an external memory accommodating unit that accommodates the external memory 280 so as be removable. Examples of the external memory 280 inserted and accommodated in the slot 270 include a memory stick and an SD memory card, but the present invention is not limited thereto. The slot 270 may be a multi-slot corresponding to a plurality of external memory standards.

The imaging apparatus 200 having the hardware structure shown in FIG. 31 can perform various processes on the image signal transmitted from the lens/solid-state image sensing device 250 to record or reproduce image data.

The lens/solid-state image sensing device 250 of the imaging apparatus 200 may include the solid-state image sensing device 100 according to the embodiment of the present invention. Therefore, the imaging apparatus 200 can prevent a reduction in the sensitivity of the solid-state image sensing device and reduce power consumption.

In the embodiment of the present invention, the imaging apparatus 200 is given as an example, but the present invention is not limited thereto. For example, the embodiment of the present invention can be applied to digital still cameras, digital video cameras, such as Handycam, which is a trademark registered by the applicant, mobile communication apparatuses, such as mobile phones having the function of a digital camera, computers, such as UMPCs (ultra mobile personal computers) having the function of a digital camera, and portable game machines, such as PlayStation Portable (registered trademark).

It should be understood by those skilled in the art that various modifications, combinations, sub-combinations and alterations may occur depending on design requirements and other factors insofar as they are within the scope of the appended claims or the equivalents thereof.

For example, in the above-described embodiment, the CMOS image sensor including amplifiers corresponding to the signal lines is given as an example of the solid-state image sensing device according to the embodiment of the present invention, as shown in FIG. 8, but the present invention is not limited thereto. For example, a CCD image sensor including the amplifiers according to the embodiment of the present invention that amplify signals using the principle of amplification according to the embodiment of the present invention may be used as the solid-state image sensing device according to the embodiment of the present invention. As described above, the amplifier according to the embodiment of the present invention can reduce the possibility that the issues of the amplifier according to the related art arise. Therefore, even when the CCD image sensor is used as the solid-state image sensing device according to the embodiment of the present invention, it is possible to prevent a reduction in the sensitivity of the solid-state image sensing device and reduce power consumption.

The above-mentioned structure is an exemplary embodiment of the present invention, and is also included in the technical scope of the present invention.

What is claimed is:

1. A solid-state image sensing device comprising:
a pixel unit that includes pixels arranged in a matrix, each of pixels having a photoelectric conversion element that generates a pixel signal corresponding to inputted light, and selectively outputting the pixel signal to a signal line connected thereto; and
an amplifying unit that includes amplifiers connected to the corresponding signal lines and amplifies the pixel signals transmitted through the signal lines,
wherein the amplifier includes
a first variable capacitance element that has a variable capacitance,
a second variable capacitance element that has a variable capacitance and that is electrically connected to the first variable capacitance element, and
an input unit that selectively inputs the pixel signal to the first variable capacitance element and the second variable capacitance element,
wherein the amplifier sets the capacitances of the first variable capacitance element and the second variable capacitance element to a first value, when the pixel signal is input to the first variable capacitance element and the second variable capacitance element, and
wherein the amplifier changes the capacitances of the first variable capacitance element and the second variable capacitance element to a second value that is smaller than the first value, thereby amplifying the pixel signal.

2. The solid-state image sensing device according to claim 1,
wherein the amplifier further includes
a third variable capacitance element that is electrically connected to the first variable capacitance element and the second variable capacitance element and has a variable capacitance, and
a fourth variable capacitance element that is electrically connected to the first variable capacitance element, the second variable capacitance element, and the third variable capacitance element and has a variable capacitance, and
wherein the capacitances of the third variable capacitance element and the fourth variable capacitance element are changed to the first value or the second value in synchronization with the first variable capacitance element and the second variable capacitance element.

3. The solid-state image sensing device according to claim 1,
wherein the first variable capacitance element and the second variable capacitance element are MOS varactors having opposite conduction types,
gate terminals of the first variable capacitance element and the second variable capacitance element are connected to the input unit,
a control signal having a first level or a control signal having a second level that is higher than the first level is input to source and drain terminals of the first variable capacitance element and source and drain terminals of the second variable capacitance element, and
the voltage level of the control signal input to the source and drain terminals of the first variable capacitance element is different from that of the control signal input to the source and drain terminals of the second variable capacitance element.

4. The solid-state image sensing device according to claim 3, wherein
the capacitances of the first variable capacitance element and the second variable capacitance element are changed to the first value, when the control signal having the second level is input to the source and drain terminals of the first variable capacitance element, and
the capacitances of the first variable capacitance element and the second variable capacitance element are changed to the second value, when the control signal having the first level is input to the source and drain terminals of the first variable capacitance element.

5. The solid-state image sensing device according to claim 1,
wherein the first variable capacitance element and the second variable capacitance element are n-channel MOS varactors,
source and drain terminals of the first variable capacitance element and a gate terminal of the second variable capacitance element are connected to the input unit,
a control signal having a first level or a control signal having a second level that is higher than the first level is input to a gate terminal of the first variable capacitance element and source and drain terminals of the second variable capacitance element, and
the voltage level of the control signal input to the gate terminal of the first variable capacitance element is different from that of the control signal input to the source and drain terminals of the second variable capacitance element.

6. The solid-state image sensing device according to claim 1,
wherein the first variable capacitance element and the second variable capacitance element are p-channel MOS varactors,
a gate terminal of the first variable capacitance element and source and drain terminals of the second variable capacitance element are connected to the input unit,
a control signal having a first level or a control signal having a second level that is higher than the first level is input to source and drain terminals of the first variable capacitance element and a gate terminal of the second variable capacitance element, and
the voltage level of the control signal input to the source and drain terminals of the first variable capacitance element is different from that of the control signal input to the gate terminal of the second variable capacitance element.

7. An amplification method that is applicable to a solid-state image sensing device including a pixel unit that includes pixels arranged in a matrix, each of pixels having a photoelectric conversion element that generates a pixel signal corresponding to inputted light, and selectively outputting the pixel signal to a signal line connected thereto, and an amplifying unit that includes amplifiers, each having a first variable capacitance element having a variable capacitance and a second variable capacitance element having a variable capacitance, connected to the signal lines and amplifies the pixel signals transmitted through the signal lines, the method comprising the steps of:
inputting the pixel signal to the first variable capacitance element and the second variable capacitance element to store a first charge corresponding to a first capacitance;
holding the first charge; and
reducing the capacitances of the first variable capacitance element and the second variable capacitance element from the first capacitance to a second capacitance that is smaller than the first capacitance, thereby amplifying the pixel signal.

8. An imaging apparatus comprising:
a solid-state image sensing device including a pixel unit that includes pixels arranged in a matrix, each of pixels having a photoelectric conversion element that generates a pixel signal corresponding to inputted light, and selectively outputting the pixel signal to a signal line connected thereto, and an amplifying unit that includes amplifiers connected to the signal lines and amplifies the pixel signals transmitted through the signal lines; and
a signal processing unit that processes the pixel signals output from the solid-state image sensing device,
wherein each of the amplifiers included in the amplifying unit of the solid-state image sensing device includes:
a first variable capacitance element that has a variable capacitance;
a second variable capacitance element that has a variable capacitance and is electrically connected to the first variable capacitance element; and
an input unit that selectively inputs the pixel signal to the first variable capacitance element and the second variable capacitance element,
when the pixel signal is input to the first variable capacitance element and the second variable capacitance element, the amplifier sets the capacitances of the first variable capacitance element and the second variable capacitance element to a first value, and
the amplifier changes the capacitances of the first variable capacitance element and the second variable capacitance element to a second value that is smaller than the first value, thereby amplifying the pixel signal.
